(19) United States
(12) Patent Application Publication
(10) Pub. No.: US 2024/0260131 A1
(43) Pub. Date: Aug. 1, 2024

(54) Method and Apparatus of Partial Sensing and DRX in Sidelink Communications

(71) Applicant: Huawei Technologies Co., Ltd., Shenzhen (CN)

(72) Inventors: Guosen Yue, Edison, NJ (US); Brian Classon, St. Pete Beach, FL (US); Vipul Desai, Palatine, IL (US)

(21) Appl. No.: 18/619,877

(22) Filed: Mar. 28, 2024

Related U.S. Application Data
(63) Continuation of application No. PCT/US2022/039444, filed on Aug. 4, 2022.
(60) Provisional application No. 63/250,766, filed on Sep. 30, 2021.

(51) Int. Cl. H04W 76/28; H04W 72/25; H04W 92/18

(52) U.S. Cl. CPC H04W 76/28; H04W 72/25; H04W 92/18

(57) ABSTRACT

A user equipment (UE) may perform partial sensing during a sidelink (SL) discontinuous reception (DRX) inactive time of the UE over a partial sensing occasion to obtain a sensing result. The partial sensing may include periodic based partial sensing (PBPS) or contiguous partial sensing (CPS), and the partial sensing occasion may include a sensing occasion determined on a most recent sensing occasion for PBPS or a minimum number of slots for CPS. The UE may determine, based on at least the sensing result, available resources for SL transmissions, and transmit a SL transmission over a resource of the available resources.

### CROSS-REFERENCE TO RELATED APPLICATIONS

This patent application is a continuation of International Patent Application No. PCT/US2022/039444, filed on Aug. 4, 2022, and entitled “Method and Apparatus of Partial Sensing and DRX in Sidelink Communications,” which claims priority to U.S. Provisional Application No. 63/250,766, filed on Sep. 30, 2021 and entitled “Method and Apparatus of Partial Sensing and DRX in Sidelink Communications,” applications of which are hereby incorporated by reference herein as if reproduced in their entireties.

### TECHNICAL FIELD

The present application relates generally to wireless communications, and in particular embodiments, to techniques and mechanisms of partial sensing and DRX in sidelink communications.

### BACKGROUND

The third generation partnership project (3GPP) has been developing and standardizing several important features with fifth generation (5G) new radio access technology (NR). In Release-16, a work item for NR vehicle-to-everything (V2X) wireless communication with the goal of providing 5G-compatible high-speed reliable connectivity for vehicular communications was completed. This work item provided the basics of NR sidelink communication for applications such as safety systems and autonomous driving. High data rates, low latencies, and high reliabilities were some of the key areas investigated and standardized.

In Release-17 (Rel-17), a work item for sidelink enhancement was approved to further enhance the capabilities and performance of sidelink communications. One objective of the work item is to introduce a user equipment (UE) coordination mechanism to facilitate sidelink communications between UEs. For example, a UE (e.g., UE A) may provide, to another UE (e.g., UE B), information about resources to use in its resource selection. It is desirable to develop further techniques and mechanisms for facilitating and enhancing sidelink communications.

### SUMMARY

Technical advantages are generally achieved, by embodiments of this disclosure which describe a method and apparatus of partial sensing and DRX in sidelink communications.

According to an aspect of the present disclosure, a method is provided that includes: performing, by a first user equipment (UE), partial sensing during a sidelink (SL) discontinuous reception (DRX) inactive time of the first UE over a first partial sensing occasion to obtain a first sensing result, the partial sensing comprising periodic based partial sensing (PBPS) or contiguous partial sensing (CPS), the first partial sensing occasion comprising a most recent sensing occasion for the PBPS or a minimum number of slots for the CPS; determining, by the first UE based on at least the first sensing result, available resources for SL transmissions; and transmitting, by the first UE, a SL transmission over a resource of the available resources.

Optionally, in any of the preceding aspects, performing the partial sensing includes: when the first UE is enabled to perform the partial sensing during the SL DRX inactive time, performing, by the first UE, the partial sensing during the SL DRX inactive time of the first UE.

Optionally, in any of the preceding aspects, the method further includes: receiving, by the first UE, configuration information enabling the first UE to perform the partial sensing during the SL DRX inactive time.

Optionally, in any of the preceding aspects, the method further includes: performing, by the first UE when outside of the SL DRX inactive time, the partial sensing over a second partial sensing occasion to obtain a second sensing result, the second partial sensing occasion comprising at least a second most recent sensing occasion for the PBPS or a configurable number of slots for the CPS; and wherein determining the available resources comprises: determining, by the first UE based on the first sensing result and the second sensing result, the available resources for SL transmissions.

Optionally, in any of the preceding aspects, the second partial sensing occasion comprises the most recent sensing occasion and the second most recent sensing occasion for the PBPS.

Optionally, in any of the preceding aspects, the most recent sensing occasion for the PBPS is a default sensing occasion configured for the first UE for the PBPS.

Optionally, in any of the preceding aspects, the configurable number of slots for the CPS is from 0 to 30, and the minimum number of slots for the CPS is 0 for an aperiodic SL transmission.

Optionally, in any of the preceding aspects, the configurable number of slots for the CPS is from 5 to 30, and the minimum number of slots for the CPS is 5 for a periodic SL transmission.

Optionally, in any of the preceding aspects, performing the partial sensing includes: determining, by the first UE, whether a slot during the SL DRX inactive time of the first UE is within the most recent sensing occasion; and when the slot is within the most recent sensing occasion, performing, by the first UE, the periodic based partial sensing in the slot.

Optionally, in any of the preceding aspects, the method further includes: when the slot is outside the most recent sensing occasion, skip performing, by the first UE, the periodic based partial sensing in the slot.

Optionally, in any of the preceding aspects, performing the partial sensing includes: performing, by the first UE, the PBPS only in the most recent sensing occasion during the SL DRX inactive time.

Optionally, in any of the preceding aspects, performing the partial sensing includes: performing, by the first UE, the PBPS in the most recent sensing occasion during the SL DRX inactive time for a resource reservation periodicity in a periodicity list.

Optionally, in any of the preceding aspects, performing the partial sensing during the SL DRX inactive time includes: receiving, by the first UE, a physical sidelink control channel (PSCCH) in the first partial sensing occasion, the PSCCH indicating a SL resource reserved by a second UE; and performing, by the first UE, reference signal received power (RSRP) measurement based on the PSCCH.

Optionally, in any of the preceding aspects, the partial sensing is performed according to a configuration that is pre-configured to the first UE or received by the first UE.

Optionally, in any of the preceding aspects, the configuration comprises one or more sensing parameters of the partial sensing, the one or more sensing parameters comprising one or more of following: a sensing periodicity list Pᵣₑₛₑᵣᵥₑ for the periodic based partial sensing; one or more sensing occasions for the periodic based partial sensing; a maximum number of sensing occasions for the periodic based partial sensing; a default sensing occasion for the periodic based partial sensing during the SL DRX inactive time; a sensing window for the contiguous partial sensing; or a minimum sensing window for the contiguous partial sensing.

According to another aspect of the present disclosure, an apparatus is provided that includes a non-transitory memory storage comprising instructions; and one or more processors in communication with the memory storage, wherein the instructions, when executed by the one or more processors, cause the apparatus to perform: performing partial sensing during a sidelink (SL) discontinuous reception (DRX) inactive time of the apparatus over a first partial sensing occasion to obtain a first sensing result, the partial sensing comprising periodic based partial sensing (PBPS) or contiguous partial sensing (CPS), the first partial sensing occasion comprising a most recent sensing occasion for the PBPS or a minimum number of slots for the CPS; determining, based on at least the first sensing result, available resources for SL transmissions; and transmitting a SL transmission over a resource of the available resources.

According to another aspect of the present disclosure, a non-transitory computer-readable media is provided. The non-transitory computer-readable media stores computer instructions, that when executed by one or more processors, cause the one or more processors to perform: performing partial sensing during a sidelink (SL) discontinuous reception (DRX) inactive time of the apparatus over a first partial sensing occasion to obtain a first sensing result, the partial sensing comprising periodic based partial sensing (PBPS) or contiguous partial sensing (CPS), the first partial sensing occasion comprising a most recent sensing occasion for the PBPS or a minimum number of slots for the CPS; determining, based on at least the first sensing result, available resources for SL transmissions; and transmitting a SL transmission over a resource of the available resources

According to another aspect of the present disclosure, an apparatus is provided that includes: a performing module configured to perform partial sensing during a sidelink (SL) discontinuous reception (DRX) inactive time of the apparatus over a first partial sensing occasion to obtain a first sensing result, the partial sensing comprising periodic based partial sensing (PBPS) or contiguous partial sensing (CPS), the first partial sensing occasion comprising a most recent sensing occasion for the PBPS or a minimum number of slots for the CPS; a determining module configured to determine, based on at least the first sensing result, available resources for SL transmissions; and a transmitting module configured to transmit a SL transmission over a resource of the available resources.

Aspects of the present disclosure facilitate UEs with SL DRX enabled to perform resource sensing during SL DRX inactive time, and provide better tradeoff between power saving and sidelink transmission reliability for sidelink communications of the UEs.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagram of an embodiment wireless communications system;

FIG. 2 is a diagram showing example in-coverage (IC) and out-of-coverage (OOC) scenarios;

FIG. 3 is a diagram of an example resource pool in the time-frequency resource grid;

FIG. 4 is a diagram of example resources for PSCCH, PSSCH and PSFCH;

FIG. 5 is a diagram showing example timing of sensing and resource selection for Rel-16 NR sidelink transmission;

FIG. 6 is a diagram of an example SL DRX cycle;

FIG. 7 is a diagram illustrating example sensing occasions for periodic based partial sensing (PBPS);

FIG. 8A and FIG. 8B are diagrams illustrating example most recent sensing occasions and second most recent sensing occasions in the PBPS for different periodicities;

FIG. 9 is a diagram showing example timing for contiguous partial sensing (CPS) for sidelink transmissions of aperiodic traffic;

FIG. 10 is a flow diagram of embodiment operations for resource sensing of a UE with sidelink DRX enabled;

FIG. 11 is a flow diagram of embodiment operations for partial sensing, where one set of partial sensing configurations is configured;

FIG. 12 is a flow diagram of embodiment operations for the PBPS, where one set of partial sensing configurations is configured;

FIG. 13 is a diagram of example sensing occasions for the PBPS;

FIG. 14 is a flow diagram showing embodiment operations for the PBPS during SL DRX active/inactive time for a given periodicity;

FIG. 15 is a flow diagram showing embodiment operations for the PBPS during SL DRX active/inactive time for multiple periodicities;

FIG. 16 is a diagram showing PBPS sensing occasions for a given periodicity;

FIG. 17 is a flow diagram of embodiment operations for the CPS;

FIG. 18 is a diagram showing embodiment CPS timing for SL transmissions of periodic traffic;

FIG. 19 is a diagram of embodiment resources allocated for PSSCH and PSFCH;

FIG. 20 is a diagram showing example SCI and reserved resources;

FIG. 21 is a flow diagram of an embodiment sidelink resource sensing method;

FIGS. 22A and 22B are diagrams of example devices that may implement embodiments methods and teachings of this disclosure; and

FIG. 23 is a block diagram of an embodiment transceiver adapted to transmit and receive signaling over a telecommunications network.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Sidelink discontinuous reception (SL DRX) is a mechanism that allows a user equipment (UE) to enter a sleep mode at regular intervals by turning off its signal reception functions, which helps save power of the UE. A UE with SL DRX enabled may receive SL signals during a SL DRX active time, and does not (or is not expected to) receive SL signals during a SL DRX inactive time. It was agreed in RAN #106-e that a UE can perform SL reception of physical sidelink control channel (PSCCH) and reference signal received power (RSRP) measurement for sensing during its SL DRX inactive time. Embodiments of the present disclosure provide methods facilitating UEs with SL DRX enabled to perform sensing for sidelink transmissions.

In some embodiments, a UE may perform partial sensing during a SL DRX inactive time of the UE over a partial sensing occasion to obtain a sensing result. The partial sensing may include periodic based partial sensing (PBPS) or contiguous partial sensing (CPS), and the partial sensing occasion may include a most recent sensing occasion for PBPS or a minimum number of slots for CPS. The UE may determine, based on at least the sensing result, available resources for SL transmissions, and transmit an SL transmission over a resource of the available resources. The UE may be enabled or disabled to perform partial sensing during the SL DRX inactive time. The UE may perform full sensing, partial sensing, or any combination(s) thereof, and selects, based thereon, one or more resources for SL communications.

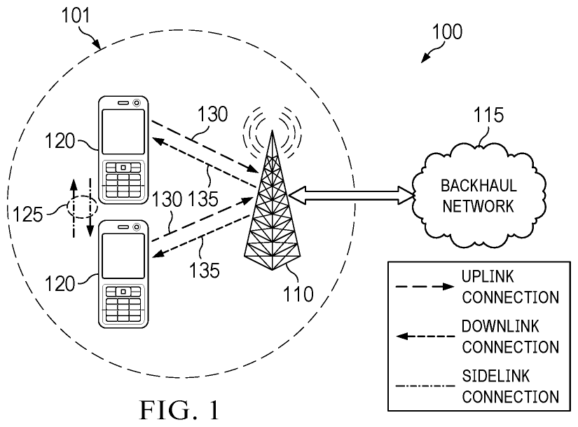

FIG. 1 is a diagram of an embodiment communications system 100. Communications system 100 includes an access node 110, with coverage area 101, serving user equipments (UEs), such as UEs 120. Access node 110 is connected to a backhaul network 115 that provides connectivity to services and the Internet. In a first operating mode, communications to and from a UE passes through access node 110. In a second operating mode, communications to and from a UE do not pass through access node 110, however, access node 110 typically allocates resources used by the UE to communicate when specific conditions are met. Communication between a UE pair in the second operating mode occurs over sidelinks 125, comprising uni-directional communication links. Communication in the second operating mode may be referred to as sidelink communication. Communication between a UE and access node pair also occur over uni-directional communication links, where the communication links from UEs 120 to the access node 110 are referred to as uplinks 130, and the communication links from the access node 110 to the UEs 120 are referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on. UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

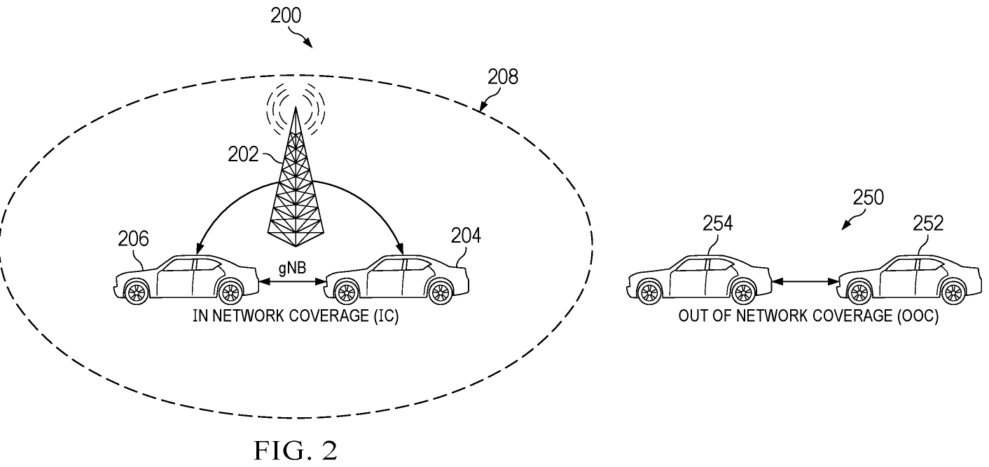

The sidelink communication can either be in-coverage, or out-of-coverage. For an in-coverage (IC) operation, a central node (e.g., access node, eNB, gNB, etc.) may be present and used to manage sidelinks. For an out-of-coverage (OOC) operation, the system operation is fully distributed, and UEs select resources on their own. FIG. 2 is a diagram showing an example IC scenario 200 and an example OOC scenario 250. In the IC scenario 200, a gNB 202 is configured to manage sidelink communications between UEs 204 and 206 that are in the coverage area 208 of the gNB 202. UEs 204 and 206 can be considered as mode 1 UEs. In the OOC scenario 250, UEs 252 and 254 perform sidelink communication with each other without management of a central node, and select resources on their own for the sidelink communication. UEs 252 and 254 can be considered as mode 2 UEs. Note UEs can operate in mode 2 while in coverage. In an embodiment of the present disclosure, some UEs may be facilitated or assisted to select their resources for sidelink communication.

For the purpose of sidelink communications, the notion of resource pools was introduced for LTE sidelink and is being reused for NR sidelink. A resource pool is a set of resources that may be used for sidelink communication. Resources in a resource pool may be configured for different channels and signals, such as control channels, shared channels, feedback channels, broadcast channels (e.g., a master information block), synchronization signals, reference signals, and so on. 3GPP TS 38.331, “NR; Radio Resource Control (RRC); Protocol specification,” V16.4.1, Mar. 30, 3021, which is herein incorporated by reference, defines rules on how the resources in the resource pool are shared and used for a particular configuration of the resource pool. A UE performing sidelink transmission may select a resource from a resource pool configured for sidelink communication, and transmit signals in the resource on a sidelink.

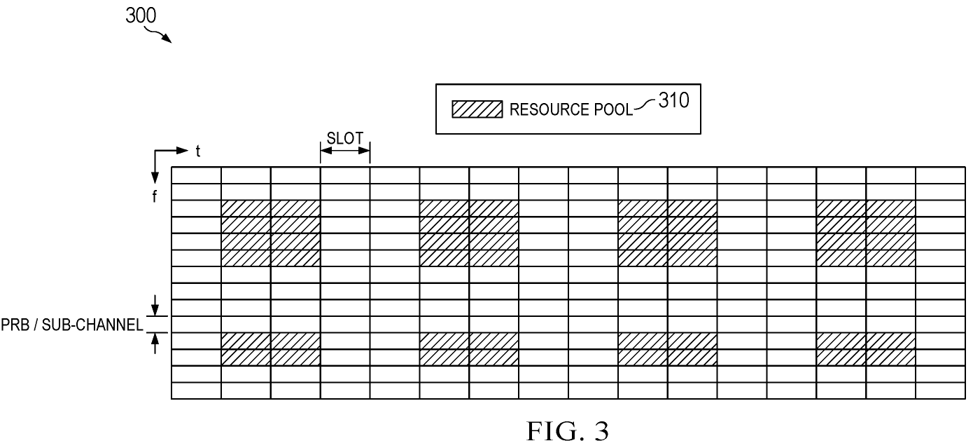

A resource pool for sidelink communication may be configured in units of slots in the time domain and physical resource blocks (PRBs) or sub-channels in the frequency domain. A sub-channel may include one or more PRBs. FIG. 3 is a diagram 300 of an example resource pool in the time-frequency resource grid. FIG. 3 shows a resource pool 310 including a plurality of resources (shaded rectangles) in different slots and PRBs/sub-channels.

According to 3GPP TS 38.211, “NR; Physical channels and modulation,” V16.5.0, Mar. 30, 3021, which is herein incorporated by reference in its entirety, for NR mobile broadband (MBB), each physical resource block (PRB) in the grid is defined as including a slot of 14 consecutive orthogonal frequency division multiplexing (OFDM) symbols in the time domain and 12 consecutive subcarriers in the frequency domain, i.e., each resource block includes 12×14 resource elements (REs). When used as a frequency-domain unit, a PRB may be 12 consecutive subcarriers. There are 14 symbols in a slot when a normal cyclic prefix is used, and 12 symbols in a slot when an extended cyclic prefix is used. The duration of a symbol is inversely proportional to the subcarrier spacing (SCS). For a {15, 30, 60, 120} kHz SCS, the duration of a slot is {1, 0.5, 0.25, 0.125} ms, respectively. A PRB may be allocated for communicating a channel and/or a signal, e.g., a control channel, a shared channel, a feedback channel, a reference signal, or a combination thereof. In addition, some REs of a PRB may be reserved. A similar time-frequency resource structure may be used on the sidelink as well. A communication resource, e.g., for sidelink communication, may be a PRB, a set of PRBs, a code (if code division multiple access (CDMA) is used, similarly to that used for a physical uplink control channel (PUCCH)), a physical sequence, a set of REs, or a combination thereof.

As used herein, a UE participating in sidelink communication is referred to as a source UE or a transmit (or transmitting, Tx) UE when the UE is to transmit signals on a sidelink to another UE. A UE participating in sidelink communication is referred to as a destination UE, a receive (or receiving, or Rx) UE or a recipient, when the UE is to receive signals on a sidelink from another UE. Two UEs communicate with each other on a sidelink are also referred to as a UE pair in sidelink communication.

A physical sidelink control channel (PSCCH) may carry sidelink control information (SCI). A source UE uses the SCI to schedule transmission of data on a physical sidelink shared channel (PSSCH) or reserve a resource for the transmission of the data on the PSSCH. The SCI may convey the time and frequency resources of the PSSCH, and/or parameters for hybrid automatic repeat request (HARQ) process, such as a redundancy version, a process id (or ID), a new data indicator, and resources for a physical sidelink feedback channel (PFSCH). The time and frequency resources of the PSSCH may be referred to as resource assignment or allocation, and may be indicated in the time resource assignment field and/or a frequency resource assignment field, i.e., resource locations. The PFSCH may carry an indication (e.g., a HARQ acknowledgement (HARQ-ACK) or negative acknowledgement (HARQ-NACK)) indicating whether a destination UE decoded the payload carried on the PSSCH correctly. The SCI may also carry a bit field indicating or identifying the source UE. In addition, the SCI may carry a bit field indicating or identifying the destination UE. The SCI may further include other fields to carry information such as a modulation coding scheme used to encode the payload and modulate the coded payload bits, a demodulation reference signal (DMRS) pattern, antenna ports, a priority of the payload (transmission), and so on. A sensing UE performs sensing on a sidelink, i.e., receiving a PSCCH sent by another UE, and decoding SCI carried in the PSCCH to obtain information of resources reserved by another UE, and determining resources for sidelink transmissions of the sensing UE.

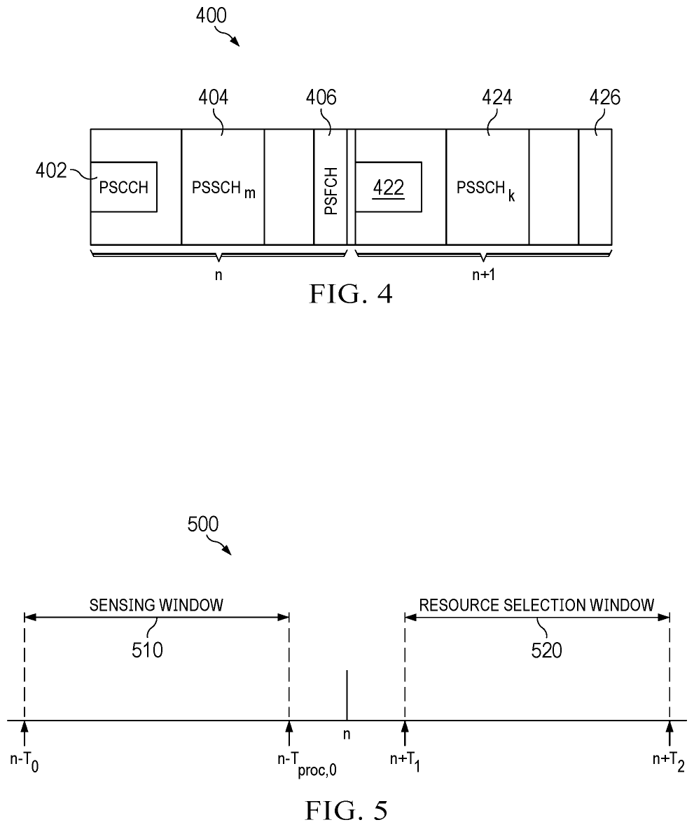

FIG. 4 is a diagram 400 of embodiment resources for PSCCH, PSSCH and PSFCH. FIG. 4 shows the resources in slot n and slot n+1. Within slot n, there are a resource region 402 for PSCCH, a resource region 404 for PSSCH (PSSCHₘ as shown), a resource region 406 for PSFCH. Within slot n+1, there are a resource region 422 for PSCCH, a resource region 424 for PSSCH (PSSCHₖ as shown), and a resource region 426 for PSFCH.

In NR, there are two stages for the SCI: a first stage (shown below) and a second stage. The first stage SCI may indicate the resources for the second stage SCI. A first stage SCI can be transmitted in the PSCCH. A second stage SCI can be transmitted in the PSSCH. The SCI may have the following formats: SCI format 1-A, SCI format 2-A and SCI format 2-B.

SCI Format 1-A (from TS 38.212)

SCI format 1-A is used for the scheduling of PSSCH and 2nd-stage-SCI on PSSCH. The following information is transmitted by means of the SCI format 1-A:
Priority—3 bits as defined in clause 5.4.3.3 of TS 23.287.
Frequency resource assignment

$$- ⌈ {log}_{2} ( \frac{{N}_{subChannel}^{SL} ( {N}_{subChannel}^{SL} + 1 )}{2} ) ⌉$$

bits when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉$$

bits when the value of the higher layer parameter sl-MaxNumPerReserve is configured to 3, as defined in clause 8.1.2.2 of TS 38.214.
Time resource assignment—5 bits when the value of the higher layer parameter sl-MaxNumPerReserve is configured to 2; otherwise 9 bits when the value of the higher layer parameter sl-MaxNumPerReserve is configured to 3, as defined in clause 8.1.2.1 of TS 38.214.
Resource reservation period—┌log₂N_{rsv_period} ┐ bits as defined in clause 8.1.4 of TS 38.214, where N_{rsv_period} is the number of entries in the higher layer parameter sl-ResourceReservePeriodList, if higher layer parameter sl-MultiReserveResource is configured; 0 bit otherwise.
DMRS pattern—┌log₂Nₚₐₜₜₑᵣₙ ┐ bits as defined in clause 8.4.1.1.2 of TS 38.211, where Nₚₐₜₜₑᵣₙ is the number of DMRS patterns configured by higher layer parameter sl-PSSCH-DMRS-TimePatternList; 0 bit if sl-PSSCH-DMRS-TimePatternList is not configured.
2nd-stage SCI format—2 bits as defined in Table 8.3.1.1-1 of TS 38.212.
Beta_offset indicator—2 bits as provided by higher layer parameter sl-BetaOffsets2ndSCI and Table 8.3.1.1-2 of TS 38.212.
Number of DMRS port—1 bit as defined in Table 8.3.1.1-3 of TS 38.212.
Modulation and coding scheme—5 bits as defined in clause 8.1.3 of TS 38.214.
Additional MCS table indicator—as defined in clause 8.1.3.1 of TS 38.214:1 bit if one MCS table is configured by higher layer parameter sl-Additional-MCS-Table; 2 bits if two MCS tables are configured by higher layer parameter sl-Additional-MCS-Table; 0 bit otherwise.
PSFCH overhead indication—1 bit as defined clause 8.1.3.2 of TS 38.214 if higher layer parameter sl-PSFCH-Period=2 or 4; 0 bit otherwise.
Reserved—a number of bits as determined by higher layer parameter sl-NumReservedBits, with value set to zero.
   SCI Format 2-A (from TS38.212)

SCI format 2-A is used for the decoding of PSSCH, with HARQ operation when HARQ-ACK information includes ACK or NACK, or when there is no feedback of HARQ-ACK information.

The following information is transmitted by means of the SCI format 2-A:
HARQ process number—┌log₂N_{process} ┐ bits as defined in clause 16.4 of TS 38.213.
New data indicator—1 bit as defined in clause 16.4 of TS 38.213.
Redundancy version—2 bits as defined in clause 16.4 of TS 38.214.
Source ID—8 bits as defined in clause 8.1 of TS 38.214.
Destination ID—16 bits as defined in clause 8.1 of TS 38.214.
HARQ feedback enabled/disabled indicator—1 bit as defined in clause 16.3 of TS 38.213.
Cast type indicator—2 bits as defined in Table 8.4.1.1-1 of TS 38.212.
CSI request—1 bit as defined in clause 8.2.1 of TS 38.214.

Table 8.4.1.1-1 of TS 38.212 is provided below.

TABLE 8.4.1.1-1
Cast type indicator

| Value of Cast type | |
|---|---|
| indicator | Cast type |
| 00 | Broadcast |
| 01 | Groupcast |
| 10 | Unicast |
| 11 | Reserved |

SCI Format 2-B (from TS38.212)

SCI format 2-B is used for the decoding of PSSCH, with HARQ operation when HARQ-ACK information includes only NACK, or when there is no feedback of HARQ-ACK information.

The following information is transmitted by means of the SCI format 2-B:
HARQ process number—┌log₂N_{process} ┐ bits as defined in clause 16.4 of TS 38.213.
New data indicator—1 bit as defined in clause 16.4 of TS 38.213.
Redundancy version—2 bits as defined in clause 16.4 of TS 38.214.
Source ID—8 bits as defined in clause 8.1 of TS 38.214.
Destination ID—16 bits as defined in clause 8.1 of TS 38.214.
HARQ feedback enabled/disabled indicator—1 bit as defined in clause 16.3 of TS 38.213.
Zone ID—12 bits as defined in clause 5.8.1.1 of TS 38.331.
Communication range requirement—4 bits as defined in TS 38.331.
   Higher Layer Messages (from TS38.331)

TS 38.331 specifies higher layer messages for configuring PSCCH, and specifies an information element (IE) SL-PSCCH-Config-r16 as shown below:

| | |
|---|---|
| SL-PSCCH-Config-r16 ::= | SEQUENCE { |
| sl-TimeResourcePSCCH-r16 | ENUMERATED {n2, n3} |
| OPTIONAL, -- Need M | |
| sl-FreqResourcePSCCH-r16 | ENUMERATED {n10,n12, n15, n20, n25} |
| OPTIONAL, -- Need M | |
| sl-DMRS-ScrambleID-r16 | INTEGER (0..65535) |
| OPTIONAL, -- Need M | |
| sl-NumReservedBits-r16 | INTEGER (2..4) OPTIONAL, -- Need M |
| ... | |
| } | |

SL-PSCCH field descriptions

sl-FreqResourcePSCCH
Indicates the number of PRBs for PSCCH in a resource pool where it is
not greater than the number PRBs of the subchannel.
sl-DMRS-ScrambleID
Indicates the initialization value for PSCCH DMRS scrambling.
sl-NumReservedBits
Indicates the number of reserved bits in first stage SCI.
sl-TimeResourcePSCCH
Indicates the number of symbols of PSCCH in a resource pool.

In Release-16, 3GPP introduced NR sidelink communication between devices such as user equipment (UE), in addition to the typical Downlink and Uplink transmission. Sidelink-communication capable devices may regularly exchange control/data information with each other.

In Release-16, two mechanisms, namely, re-evaluation and pre-emption, were introduced in sidelink communications to reduce the collision rate and improve the packet reception ratio performance.

Re-evaluation mechanism: After a transmit UE selects a sidelink resource and reserves the selected sidelink resource, it can continue a sensing process to check whether the reserved resource is still available. To achieve this, the UE may keep monitoring SCI on sidelink resources and perform a resource selection procedure, e.g., the procedure as defined in TS38.214, Section 8.1.4, performing a resource exclusion process in a reduced resource selection window based on sensing outcome to form an available resource set. If the reserved resource is not in the available resource set, the UE performs resource re-selection and selects a new resource to avoid a potential collision. As an example, the UE may determine, from a resource pool, a set of resources that is available for the UE to use for sidelink communication. The UE may select a resource from the available resource set and reserves the selected resource. The UE may then re-determine the resource set, e.g., by excluding one or more resources that are not available (e.g., based on a received SCI indicating a resource reserved by another UE) or adding one or more resources that are available. The UE may check whether the selected resource is included in the re-determined resource set (or referred to as an updated resource set). If the selected resource is not included in the re-determined resource set (which may indicate that this resource is not available for the UE anymore), the UE may re-select a resource from the re-determined resource set for sidelink communication.

Pre-emption mechanism: After a transmit UE (e.g., UE1) selects and reserves a sidelink resource, it can continue a sensing process to check whether the reserved resource is still available, as described above. In an example, UE1 may find out that the reserved resource is not included in the updated available resource set and occupied by another UE (e.g., UE2), e.g., by decoding SCI 1 from UE2. UE2 may be referred to as a collided UE. In this case, UE1 may detect a priority of data to be transmitted by UE2. If a priority of data to be transmitted by UE1 (referred to as a sensing UE, as it performs the sensing process) is lower than that of the UE2's data, the sensing UE (UE1) may release its reserved resource and re-select a resource in the resource selection window, e.g., in the updated available resource set. If UE1's data has a higher priority, UE1 may continue to reserve the resource and transmit its data using the reserved resource on sidelink.

There are 8 packet priority levels for sidelink data traffic, i.e., 1,2, . . . , 8, indicated by a 3-bit number p in a priority field of SCI in the SCI format 1-A. p is from 0 to 7, and a value of a priority (or priority level) is equal to p+1. It is noted that a smaller or lower value (p+1) of priority indicates a higher priority (level) according to TS23.303. The smallest value of priority, i.e., 1, indicates the highest priority, and the largest value of priority, i.e., 8, indicates the lowest priority level.

The priority level of sidelink data may be set by the application layer and is provided to the physical layer.

At RAN #90e, a Rel-17 work item on sidelink enhancements was updated (RP-202846) and was agreed with the following objective on sidelink power savings:
Specify resource allocation to reduce power consumption of the UEs [RAN1, RAN2]
   Baseline is to introduce the principle of Rel-14 LTE sidelink random resource selection and partial sensing to Rel-16 NR sidelink resource allocation mode 2.
   Note: Taking Rel-14 as the baseline does not preclude introducing a new solution to reduce power consumption for the cases where the baseline cannot work properly.
   This work should consider the impact of sidelink discontinuous reception (DRX), if any.

In Rel-16 NR vehicle-to-everything (V2X) sidelink communications, mode 2 UEs transmit and receive information without network management. UEs allocate resources for themselves from a resource pool for sidelink transmissions. The resource allocation relies on a sensing and reservation process as shown in FIG. 5. FIG. 5 is a diagram 500 showing example timing of sensing and resource selection for Rel-16 NR sidelink transmission, which is usually referred as full sensing. The diagram 500 includes a sensing window 510 during which a UE may monitor availability of sidelink resources and a resource selection window 520 during which the UE may select an available sidelink resource.

During a sensing procedure, a UE that is to perform sidelink transmission (also referred to as a monitoring UE or sensing UE, transmitting UE as the UE is to transmit SL traffic) detects an SCI transmitted in each slot in the sensing window 510 and measures received signal receive power (RSRP) of the resource indicated in the SCI. The monitoring UE may also receive transmissions of data during the sensing window 510 (thus, the monitoring UE is also a receiving UE). For resource reservations for sidelink transmissions of periodic traffic, if a UE occupies a resource on slot sₘ (e.g., a UE k occupies resource on slot sₘ), it will also occupy resource(s) on slot sₘ+q*RRIₖ, where q is an integer, and RRIₖ is a resource reservation interval of the UE k that the sensing UE detected. The monitoring UE may detect the SCI of the UE k and the resource occupied by the UE k. Detecting the SCI by the monitoring UE may include the steps of receiving and decoding a PSCCH and processing the SCI within the PSCCH, for example.

For aperiodic or dynamic transmissions, a transmitting UE (e.g., the UE k) in sidelink communications may reserve multiple resources and indicate the next resource in its SCI. Therefore, based on the sensing result of the monitoring UE (e.g., based on detection of SCI of UE k), the monitoring UE can determine which resources may be occupied in the future and can avoid selecting those resources for its own sidelink transmission. The monitoring UE may determine whether a resource is occupied based on measured RSRP on the resource during the sensing period (the sensing window 510). For example, if the measured RSRP on the occupied resource during the sensing period is above a RSRP threshold, the monitoring UE may avoid the occupied resource, as in the resource exclusion procedure described in TS38.214.

When resource selection is triggered on slot n, based on the sensing result of the monitoring UE in the sensing window 510, i.e., on slots [n-T₀, n-T_{proc,0}], the monitoring UE may select sidelink resources in a resource pool during the resource selection window 520, i.e., on slots [n+T₁, n+T₂]. The variables are defined as follows:
T₀: number of slots with the value determined by resource pool configuration;
T_{proc,0}: time required for a UE to complete the sensing process;
T₁: processing time required for identification of candidate resources and resource selection T₁≤T_{proc,1};
T₂: the last slot of resource pool for resource selection which is left to UE implementation but in the range of [T₂ₘᵢₙ, PDB] where T₂ₘᵢₙ is minimum value of T₂ and PDB denotes packet delay budget, i.e., the remaining time for UE transmitting the data packet.
T_{proc,1}: maximum time required for a UE to identify candidate resources and select new sidelink resources;

To select a resource, the transmitting UE (which senses the resources for sidelink transmission) may identify the candidate resources (or available resources) by excluding the occupied resources that have measured RSRP over a configured RSRP threshold. The transmitting UE may compare a ratio (also referred to as available resource ratio) of the available resources over all resources in the selection window 520. If the available resource ratio is greater than a threshold X %, then the transmitting UE may select a resource randomly among the candidate resources. If the available resource ratio is not greater than X %, the transmitting UE may increase the RSRP threshold by 3 dB and check the available resource ratio until the available resource ratio is equal to or greater than X %. X may be chosen from a list, sl-TxPercentageList, and its value is determined by data priority, as specified in TS38.214:
sl-TxPercentageList: internal parameter X for a given prio_{TX} is defined as sl-TxPercentageList (prio_{TX}) converted from percentage to a ratio.

Possible values of X in sl-TxPercentageList are 20, 35, and 50, as specified in TS38.331 shown below:

| | |
|---|---|
| SL-TxPercentageList-r16 ::= | SEQUENCE (SIZE (8)) OF SL-TxPercentageConfig-r16 |
| SL-TxPercentageConfig-r16 ::= | SEQUENCE { |
| sl-Priority-r16 | INTEGER (1..8), |
| sl-TxPercentage-r16 | ENUMERATED {p20, p35, p50} |
| } | |

For periodic resource reservation, a resource reservation period is provided by higher layers with an index in the list sl-ResourceReservePeriodList corresponding to the resource reservation period. The list includes a set of resource reservation period allowed in the resource pool. A maximum of 16 reservation periods can be configured for a UE, which are selected from the specified resource reservation periods in Rel. 16 (sl-ResourceReservePeriod-r16). The list sl-ResourceReservePeriodList and all possible values of sl-ResourceReservePeriod-r16, i.e., {0, [1:99], 100, 200, 300, 400 500, 600, 700, 800, 900, 1000} (in milliseconds), are specified in TS38.331 as:

| | |
|---|---|
| SL-UE-SelectedConfigRP-r16 ::= | SEQUENCE { |

| | |
|---|---|
| sl-CBR-PriorityTxConfigList-r16 | OPTIONAL, -- Need M |

| | |
|---|---|
| sl-ThresPSSCH-RSRP-List-r16 | OPTIONAL, -- Need M |

| | |
|---|---|
| sl-MultiReserveResource-r16 | ENUMERATED {enabled} |

OPTIONAL, -- Need M

| | |
|---|---|
| sl-MaxNumPerReserve-r16 | ENUMERATED {n2, n3} |

OPTIONAL, -- Need M

| | |
|---|---|
| sl-SensingWindow-r16 | ENUMERATED {ms100, ms1100} |

OPTIONAL, -- Need M

| | |
|---|---|
| sl-SelectionWindowList-r16 | OPTIONAL, -- Need M |

| | |
|---|---|
| sl-ResourceReservePeriodList-r16 | SEQUENCE (SIZE (1..16)) OF SL- |

| | |
|---|---|
| ResourceReservePeriod-r16 | OPTIONAL, -- Need M |
| sl-RS-ForSensing-r16 | ENUMERATED {pscch, pssch}, |

...
}

| | |
|---|---|
| SL-ResourceReservePeriod-r16 ::= | CHOICE { |
| sl-ResourceReservePeriod1-r16 | ENUMERATED {ms0, ms100, ms200, ms300, ms400, |

ms500, ms600, ms700, ms800, ms900, ms1000},

| | |
|---|---|
| sl-ResourceReservePeriod2-r16 | INTEGER (1..99) |

}

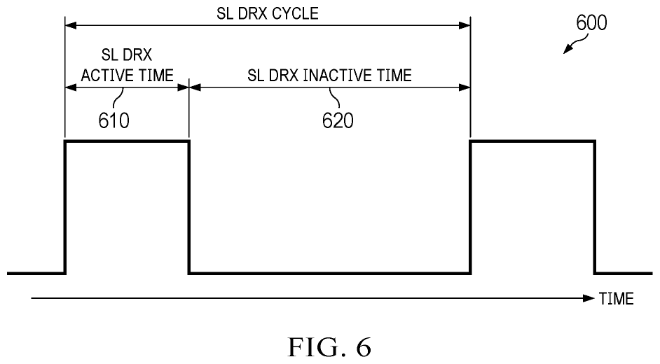

Sidelink discontinuous reception (SL DRX) is also a mechanism for SL power saving, which allows a UE to enter a sleep mode at regular intervals by turning off its signal reception functions. In the following description, the terms “SL DRX” and “DRX” are used interchangeably. FIG. 6 is a diagram of an example SL DRX cycle 600. Similar to UE DRX at Uu link, the SL DRX cycle 600 includes a SL DRX active time (or SL DRX on time/duration/period, SL DRX active duration/period) 610 and a SL DRX inactive time (or SL DRX off time/duration/period, SL DRX inactive duration/period) 620. A UE receives sidelink signals during the SL DRX active time 610. During the SL DRX inactive time 620, the UE does not (or is not expected to) receive PSSCH.

One question may be whether the UE performs reception of PSCCH so that the UE can perform sensing or partial sensing for resource selection during the SL DRX inactive time 620. If the DRX on/off setting and partial sensing are independent from each other, not performing partial sensing during the SL DRX off period will impact the resource selection performance significantly. In RAN #106-e, the following agreement has been reached:

A UE can perform SL reception of PSCCH and RSRP measurement for sensing during its SL DRX inactive time.
For future study (FFS): When such reception and measurement is performed, whether it is subject to specification, or is up to UE implementation
FFS: Other details

Based on the agreement, a UE is allowed to perform sensing during the SL DRX inactive time. In the agreement, it was allowed to study whether the sensing performed during the SL DRX inactive time is subject to a certain specification or is up to UE implementation, as well as other details that are needed. Embodiments of the present disclosure provide approaches for specifying the relationship between partial sensing occasions and SL DRX in order to achieve better tradeoff between power saving and sidelink transmission reliability. Exemplary approaches are provided for the relationship between periodic based partial sensing and SL DRX, and between contiguous partial sensing and SL DRX. Embodiments of the present disclosure also describe several techniques to reduce sidelink power consumption. The techniques can be used for all UEs, e.g., applicable for public safety (PS) UEs.

As specified in updated work item description (WID) on sidelink enhancements in RP-202846Error! Reference source not found., for power efficient resource allocation, one of the objectives for specifying resource allocation to reduce power consumption is to consider the impact of sidelink DRX, if there is any. Based on the previously described agreement on SL DRX, a UE is allowed to perform sensing during the sidelink DRX inactive time. Thus, there is clearly an impact of sidelink DRX on SL sensing (full sensing), partial sensing and resource allocation. Some specification is needed to fulfill the objectives listed in the WID. For a SL transmission, there is a transmit (Tx) UE and a receive (Rx) UE. The SL DRX may be enabled at both the Tx UE and the Rx UE for this Tx-Rx link, as the Tx UE for this SL transmission may also receive a data packet from other UEs. To resolve the issue caused by the SL DRX impact, the SL DRX impact may be considered when SL DRX is enabled at the Tx UE and/or when the SL DRX is enabled at the Rx UE. If only considering the SL DRX impact in a case where SL DRX is enabled at the Tx UE regardless whether SL DRX is enabled at the Rx UE, the impact is then on the partial sensing for resource allocation at the Tx UE, as sensing or reception of PSCCH is a receive function. In this case, it will not fulfill the design objective of the work item of sidelink enhancement if performing sensing during the SL DRX inactive time is left to UE implementation, i.e., SL DRX and partial sensing/resource allocation are completely independent to each other. Therefore, the UE sensing during the SL DRX inactive time shall be subject to some specifications.

Embodiments of the present disclosure provide solutions on how a UE performs sensing during the SL DRX inactive time. Since performing partial sensing during the SL DRX off period will affect the power saving efficiency, it would be beneficial to align partial sensing with the SL DRX on period as much as possible, when partial sensing is also performed during the SL DRX off period per 3GPP RAN1 agreement. However, there is no criterion on the alignment. It would be necessary and helpful to provide some specifications on the alignment.

### Partial Sensing in NR

As described in the Rel-17 work item on sidelink enhancements (RP-202846), partial sensing was introduced to NR sidelink. Two partial sensing schemes were discussed in RAN1 meetings, i.e., periodic based partial sensing (PBPS) and contiguous partial sensing (CPS), and were agreed to be included in 5G NR Rel-17.

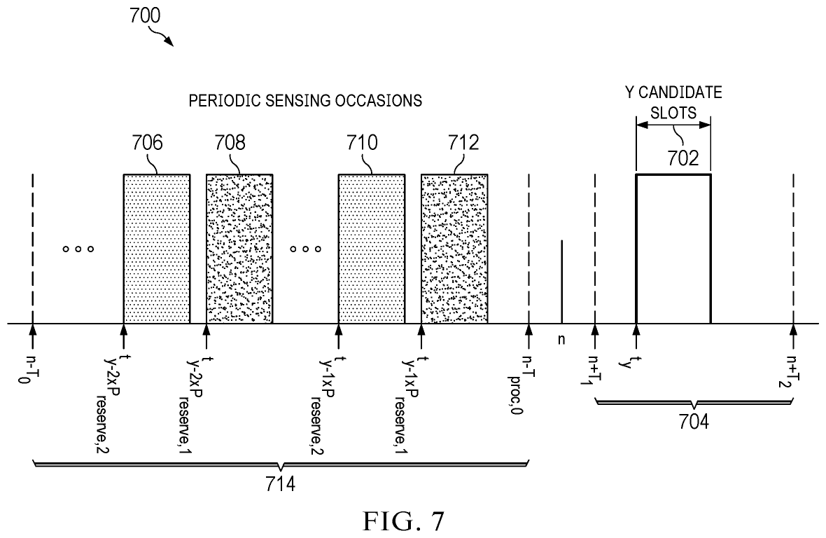

FIG. 7 is a diagram 700 illustrating sensing occasions for PBPS. As shown in FIG. 7, when periodic based partial sensing is enabled, a set of Y candidate slots 702 in a resource selection window 704 are formed for resource selection. Y is an integer greater than 0. The sensing occasions for PBPS may be referred to as periodic sensing occasions. A UE may monitor one or more periodic sensing occasions 706, 708, 710 and 712 in a sensing window 714 for the Y candidate slots 702 in the resource selection window 704. The resource selection window 704 and the sensing window 714 are similar to those described with respect to FIG. 5. The UE may perform PBPS in the one or more periodic sensing occasions 706-712 to determine whether one or more slots in the Y candidate slots 702 are not occupied or available. Based on sensing results, the UE forms a set of available resources on the set of Y slots in the resource selection window 702, and selects one or more resources from the set of available resources for a sidelink transmission.

In a resource pool (pre-)configured with at least partial sensing, if a UE performs periodic based partial sensing, at least when the reservation for another TB is enabled for the resource pool and resource selection/reselection is triggered at slot n, the UE may monitor slots of at least one periodic sensing occasion, where a periodic sensing occasion is a set of slots for a given periodicity for sensing a slot within the Y candidate slots, and may be represented as:

$${t}_{y - k \times {P}_{reserve}}^{SL} ,$$

where y is an index of a slot in the Y candidate slots, t_{y} is the timing or an absolute slot number of the slot (t_{y} represents a slot in the Y candidate slots, y=1, 2, . . . Y, or y=0, 1, . . . Y−1), Pᵣₑₛₑᵣᵥₑ is an allowed resource reservation period, and k indicates the number of the resource reservation periods before slot t_{y} for the given Pᵣₑₛₑᵣᵥₑ·Pᵣₑₛₑᵣᵥₑ may also be referred to as a periodicity. According to TS 38.214, the value of Pᵣₑₛₑᵣᵥₑ corresponds to sl-PBPS-OccasionReservePeriodList if configured, otherwise, the values correspond to all periodicity from sl-ResourceReservePeriodList. A value of k defines a sensing slot for a given slot within the Y candidate slots and for a given periodicity. For example, as shown in FIG. 7, sensing slots for the slot t_{y} in the Y candidate slots 702 include sensing slots t_{y-2*Preserve 1}, t_{y-2*Preserve,2}, t_{y-1*Preserve,1}, t_{y-1*Preserve,2}, where P_{reserve,1} and P_{reserve,2} are different periodicities. For all slots in the Y candidate slots, a set of k values forms a sensing occasion for a given periodicity with each slot in the Y candidate slots having a corresponding sensing slot. The set of k values can be same, e.g., k=1 for a given periodicity and for all the Y candidate slots indicates a set of slots with each slot being a period ahead of a slot in the Y candidate slots. It is not yet agreed in RAN1 whether a sensing occasion is specified for all configured Pᵣₑₛₑᵣᵥₑ or each Pᵣₑₛₑᵣᵥₑ. The superscript “SL” in t_{y-k×P}_{ᵣₑₛₑᵣᵥₑ}^{SL} represents “sidelink” and is omitted in the description for illustration convenience only.

For a set of Pᵣₑₛₑᵣᵥₑ, it was agreed in RAN1 that if there is no (pre-)configuration (i.e., by default), Pᵣₑₛₑᵣᵥₑ corresponds to all values from the (pre-)configured set sl-ResourceReservePeriodList. Otherwise, a single set of Pᵣₑₛₑᵣᵥₑ values may be (pre-)configured, where the set of Pᵣₑₛₑᵣᵥₑ values may be restricted to a subset of the (pre-)configured set sl-ResourceReservePeriodList. A UE by implementation may also monitor other sl-ResourceReservePeriodList values that are not part of the restricted subset.

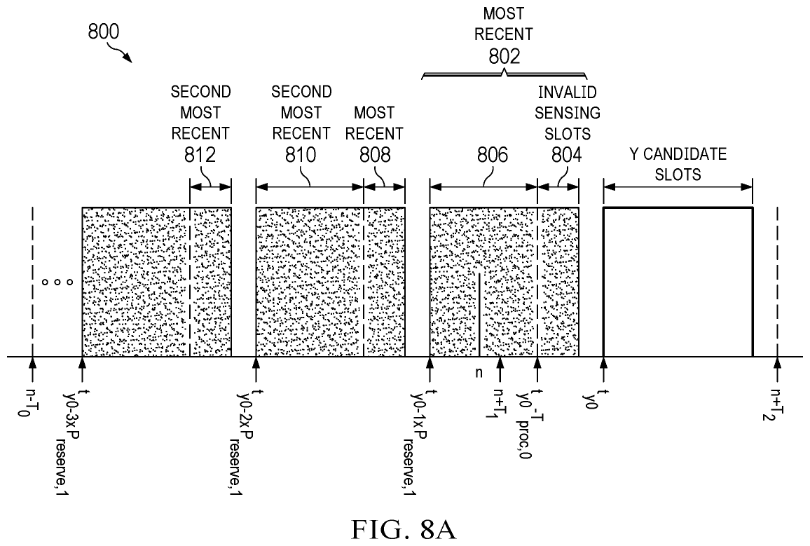

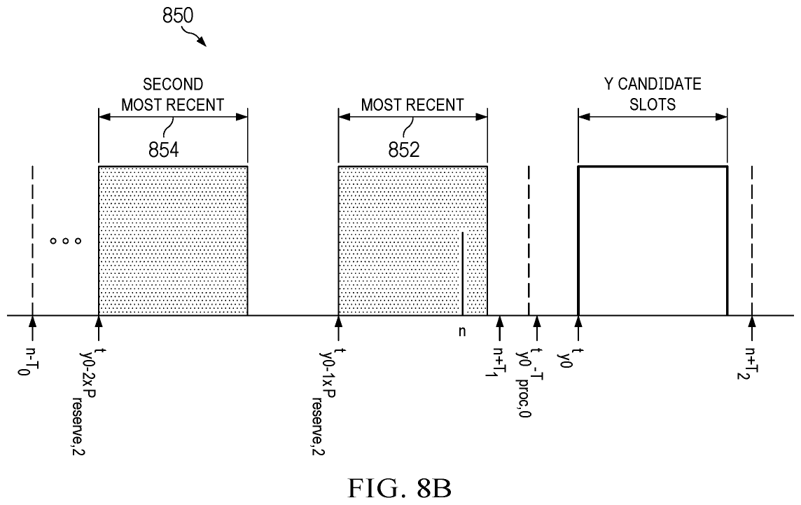

FIG. 8A and FIG. 8B are diagrams 800 and 850 illustrating the most recent sensing occasions and the second most recent sensing occasions in periodic based partial sensing for two respective periodicities: (a) for P_{reserve,1}, (b) for P_{reserve,2}. FIG. 8A shows periodic sensing occasions for Y candidate slots in a resource selection window when k=1, 2, 3 for P_{reserve,1}. FIG. 8B shows periodic sensing occasions for the Y candidate slots when k=1, 2 for P_{reserve,2}. As used herein, sensing slots for the Y candidate slots for a given k and a given Pᵣₑₛₑᵣᵥₑ may be referred to as a slot group, e.g., sensing slots 802 form a slot group. For periodic sensing occasions, it was agreed that by default, a UE monitors the most recent sensing occasion for a given reservation periodicity before the resource (re)selection trigger slot n or the first slot of the set of Y candidate slots, subject to processing time restriction. The most recent sensing occasion for the slot t_{y} is determined based on t_{y-k×p}_{ᵣₑₛₑᵣᵥₑ} with respect to the slot t_{y} subject to the processing time, and is defined as a slot t_{y-k×p}_{ᵣₑₛₑᵣᵥₑ} with the minimum k>0, which is a valid sensing slot for the given Pᵣₑₛₑᵣᵥₑ with respect to the candidate slot t_{y}. The most recent sensing occasion is illustrated for two different periodicities. As shown in FIG. 8A for the given P_{reserve,1}, when k=1, sensing slots t_{y-1×P}_{_{reserve,1}} 802 with respect to t_{y}, y=y₀, . . . , y_{y-1}, may have some slots 804 overlapping the slots for sensing processing time. The UE cannot perform sensing on these overlapping slots 804. Other than these overlapping slots 804, the slots t_{y-1×P}_{_{reserve,1}} 806 for k=1, can be used as sensing slots for the corresponding slots t_{y}. These non-overlapping slots 806 when k=1 represent the most recent sensing slots for slots t_{y}, y=y₀, . . . , y_{y-1}. For the overlapping slots 804 in t_{y-1×P}_{_{reserve,1}}, the corresponding slots 808 in the slot group of t_{y-2×p}_{_{reserve,1}} for k=2 are valid sensing slots. Then for those corresponding t_{y}, slots t_{y-2×P}_{_{reserve,1}} 808, when k=2, represent the most recent sensing slots for the given periodicity, P_{reserve,1}. These two sets of slots 806 and 808 form the most recent sensing occasion for the given periodicity, Pᵣₑₛₑᵣᵥₑ, 1 for the configured Y candidate slots. Similarly, a part of slots t_{y-2×p}_{_{reserve,1}}, i.e., slots 810 and a part of slots t_{y-3×P}_{_{reserve,1}}, i.e., slots 812 form the second most recent sensing occasion (or the last periodic sensing occasion prior to the most recent) for the given periodicity, P_{reserve,1}, as shown in FIG. 8A. FIG. 8 Error! Reference source not found. B illustrates the most recent sensing occasion for P_{reserve,2}. Since there is no overlap with the slots for the necessary sensing processing time on the slots t_{y-1×p}_{_{reserve,2}} for y=y₀, . . . , y_{y-1}, the most recent sensing occasion is the slot group 852 of t_{y-1×P}_{_{reserve,2}} for k=1, and the second most recent sensing occasion is the slot group 854 t_{y-2×p}_{_{reserve,2}} for k=2.

It was also agreed in RAN1 that if (pre-)configured, a UE may additionally monitor periodic sensing occasions that correspond to a set of values k which can be (pre-)configured with at least one value. The possible values may correspond to the most recent sensing occasion for a given reservation periodicity before the resource (re)selection trigger slot n or the first slot of the set of Y candidate slots, and the last periodic sensing occasion prior to the most recent one for the given reservation periodicity are included. So far other values are not precluded, and the maximum number of sensing occasions is yet to be decided. Other values can include, for example, the third most recent sensing occasion may be included. If a maximum number of sensing occasions is specified, the sensing occasions can be configured within the maximum number of sensing occasion, and the most recent sensing occasion must be included.

Aperiodic/dynamic transmission is supported in sidelink communications. For sidelink resource allocation, a UE may detect possible aperiodic traffic from other UEs to avoid resource conflicts. For this purpose, a UE may perform contiguous partial sensing for resource (re)selection. It was noted in RAN1 #104-e that contiguous partial sensing (or contiguous based partial sensing) can be specified for resource allocation for both periodic traffic and aperiodic traffic for a sensing UE.

For aperiodic traffic, a UE selects multiple candidate resources, but with the restriction that the gap between two consecutive candidate resources must be smaller than 32 slots. For example, when a resource is selected on slot m₁, the other candidate resource will be located in the range of slots [m₁−31, m₁+31]. Therefore, to select resources in the resource pool, it is meaningless to monitor slots that are 32 slots before the first slot of the resources within the resource selection window. At the sensing UE, for periodic traffic with Y candidate slots, it is then meaningless to monitor the slot t_{y0}−32 or slots before t_{y0}−32, where t_{y0} is the first slot of the Y candidate slots.

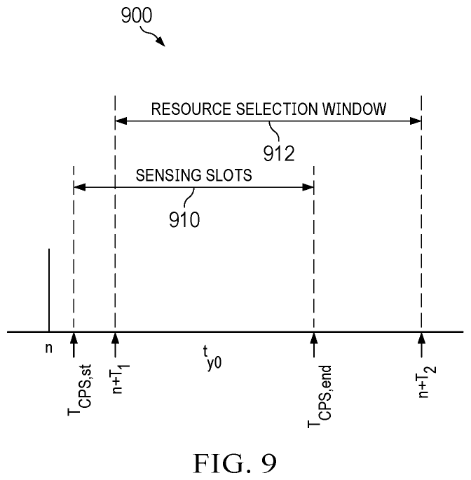

FIG. 9 is a diagram 900 showing example timing for contiguous partial sensing for SL transmissions of aperiodic traffic. A sensing UE with aperiodic traffic to be transmitted may sense resource availability in a contiguous sensing window 910, and select a resource for aperiodic traffic transmission in a resource selection window 912, as shown in FIG. 9. The contiguous sensing window 910 includes a set of slots in a range of [T_{CPS,st}, T_{CPS,end}]. According to the agreement in RAN1 #104-e for contiguous partial sensing, a UE monitors slots between [n+T_{A}, n+T_{B}], thus in this case, T_{CPS,st}=n+T_{A} and T_{CPS,end}=n+T_{B}. For UEs with periodic traffic, the triggering slot for resource selection is known in advance. However, for a UE with aperiodic traffic, a data packet may arrive at any time without any prior knowledge. Therefore, it is impossible for the UE to know in advance when resource selection is triggered at slot n. Contiguous based partial sensing can be configured for aperiodic traffic which can start after n, i.e., T_{CPS,st}>n, as shown in FIG. 9 Error! Reference source not found,. The earliest possible starting point to perform sensing may be T_{CPS,st}=n+1, i.e., T_{A}=1. The contiguous partial sensing may start before slot n, i.e., T_{A} can be negative. The contiguous partial sensing may be used to detect aperiodic traffic from other UEs. The sensing results for aperiodic traffic from other UEs may only be beneficial for resource selection on the slots [T_{CPS,end}+T_{proc,1}, T_{CPS,end}+31].

Based on the agreement on SL DRX, a UE can perform SL reception of PSCCH and RSRP measurement for sensing during its SL DRX inactive time. Since partial sensing is possibly an optional UE feature in Rel-17, a UE may not support this feature. However, if a UE supports the full sensing feature but not partial sensing, based on the agreement, the UE may need to perform sensing on all slots in the SL DRX inactive time that overlaps with the full sensing window, e.g., the sensing window 510 in FIG. 5, which will affect the power saving efficiency considerably. Therefore, it would be beneficial that when a UE supports SL DRX in SL mode 2, the UE also supports partial sensing.

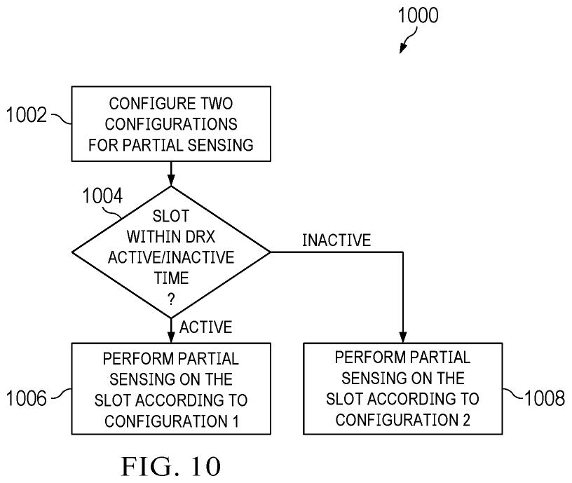

In some embodiments, when a UE has SL DRX enabled, two sets of partial sensing parameters may be configured for the UE to perform partial sensing. FIG. 10 is a flow diagram of embodiment operations 1000 for resource sensing of a UE with SL DRX enabled. As shown, the UE may be configured with two configurations (e.g., configuration 1 and configuration 2) for partial sensing (block 1002), e.g., for PBPS and CPS respectively. The UE may be pre-configured with the configurations, or receive the configurations from the network. The configuration 1 and configuration 2 may respectively include a first set of configured sensing parameters and a second set of configured sensing parameters. For PBPS, the sensing parameters may include a sensing periodicity list of Pᵣₑₛₑᵣᵥₑ or a default sensing periodicity, one or more sensing occasions, a maximum number of sensing occasions, a default sensing occasion for sensing during the SL DRX inactive time, and so on. Note that default setting on sensing periodicity list or sensing occasions as discussed in the agreement may be considered as one type of configuration. For CPS, the parameters may include sensing window parameters, e.g., T_{A} and T_{B}, a minimum sensing window, and so on. The UE may determine whether a slot is within the DRX active time or DRX inactive time of the UE (block 1004). When the slot is within the DRX active time of the UE, the UE may perform partial sensing on the slot according to the configuration 1 (block 1006), e.g., according to the first set of configured sensing parameters. When the slot is within the DRX inactive time of the UE, the UE may perform partial sensing on the slot according to the configuration 2 (block 1008), e.g., the second set of configured sensing parameters.

Note that each set of partial sensing configurations can include configurations for periodic based partial sensing, for contiguous partial sensing, or both. It is possible that there is overlap between the two sets of configurations, meaning that certain configured parameters in the two sets of configurations are the same.

In some embodiments, two parameter sets (or two configurations) may be configured for partial sensing, and a UE may perform partial sensing as follows:
The UE performs partial sensing according to a first set of parameters when SL DRX is not enabled for the UE.
The UE performs the partial sensing according to a second set of parameters when SL DRX is enabled for the UE. The UE performs partial sensing according to the second set of parameters during both active and inactive time.

One specific case for this embodiment is that some specified configuration or settings may be enforced for partial sensing when SL DRX is enabled. For example, for PBPS, when SL DRX is enabled, only a default sensing occasion, e.g., the most recent sensing occasion, is supported. In this case, a UE may perform partial sensing on the slots of the most sensing occasion for a given periodicity in a periodicity list regardless whether the UE is in the SL DRX active time or the SL DRX inactive time. This may incur certain performance degradation as it does not utilize the SL DRX active time for additional sensing. But it may achieve better power saving performance as desired by enabling SL DRX.

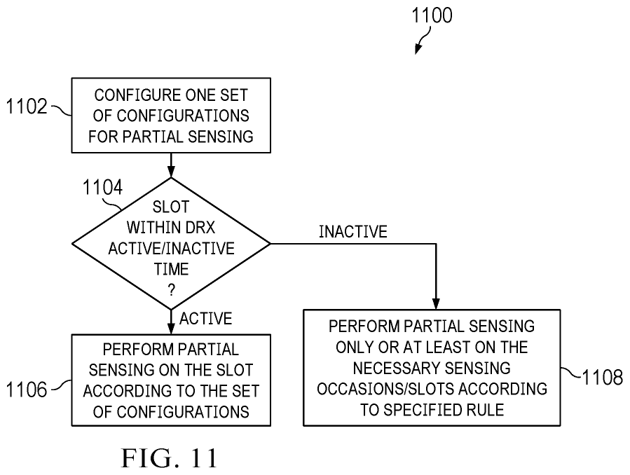

Embodiments of the present disclosure provide another approach for a partial sensing on DRX inactive period with DRX enabled. In some embodiments, when SL DRX is enabled, one set of partial sensing parameters may be configured, which can be the same as that when SL DRX is not enabled. Certain rules may be specified on procedures of a UE performing sensing during the SL DRX active and inactive time. Some minimum sensing requirements (e.g., necessary sensing occasions for periodic based partial sensing and sensing window for contiguous partial sensing) may be specified for the UE to perform the sensing during the DRX inactive time. FIG. 11 illustrates an example of sensing and SL DRX with one configured parameter set and specified rules/configurations for sensing during the SL DRX inactive time. During the SL DRX active time of a UE, the UE may perform sensing according to configured sensing parameter set. During the SL DRX inactive time, the UE may perform sensing on the necessary sensing slots to fulfill the minimum sensing requirement. A rule may be defined to specify the minimum sensing requirement. The rule may specify that during the SL DRX inactive time, a UE may perform partial sensing only or at least on certain sensing occasions or slots.

For the minimum requirements on the sensing or necessary sensing occasions/slots during the DRX inactive time, the UE may perform partial sensing only on the necessary sensing slots specified by the requirements or rule (“only” behavior), or at least on the necessary sensing slots specified by the requirements or rule (“at least” behavior”). That is, the UE may have two UE behaviors: the “only” behavior and the “at least” behavior. The two UE behaviors are as follows.
“Only”: a UE performs sensing during the SL DRX inactive time only on specified slots/occasions to fulfill the minimum requirements but not on other slots.
“At least”: a UE is required to perform sensing during the SL DRX inactive time on the specified slots/occasions to fulfill the minimum requirements. For other slots, it is left to UE implementation.

A UE may support one or the other of these two behaviors.

FIG. 11 is a flow diagram of embodiment operations 1100 for partial sensing. In this example, a UE may be configured with a set of configurations for partial sensing, e.g., PBPS and/or CPS (block 1102). The UE may be pre-configured with the configurations, or receive the configurations from the network. The set of configurations may include a set of sensing parameters. For PBPS, the set of sensing parameters may include a sensing periodicity list of Pᵣₑₛₑᵣᵥₑ or a default sensing periodicity, one or more sensing occasions, a maximum number of sensing occasions, a default sensing occasion for sensing during the SL DRX inactive time, and so on. For CPS, the set of sensing parameters may include sensing window parameters, e.g., T_{A} and T_{B}, a minimum sensing window, and so on. The UE may determine whether a slot is within the SL DRX active time or SL DRX inactive time of the UE (block 1104). When the slot is within the SL DRX active time of the UE, the UE may perform partial sensing on the slot according to the configured set of configurations (block 1106), e.g., according to the set of sensing parameters. When the slot is within the SL DRX inactive time of the UE, the UE may perform partial sensing only or at least on necessary sensing occasions/slots according to a specified rule (block 1108). If the slot belongs to the necessary sensing occasions/slots, the UE may perform the partial sensing on the slot.

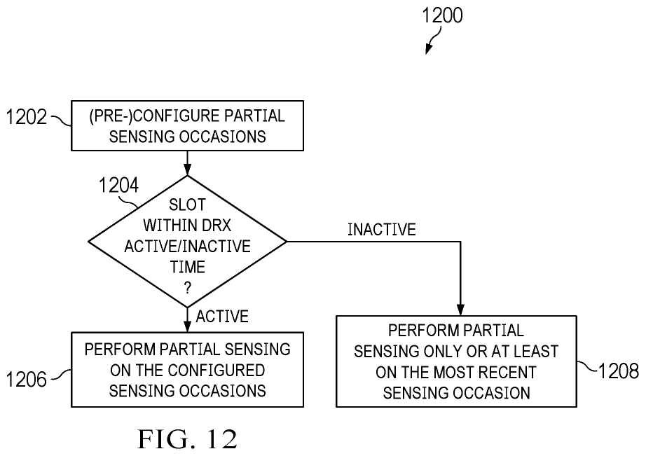

FIG. 12 is a flow diagram of embodiment operations 1200 for partial sensing, where one set of configurations (or one set of sensing parameters) is configured for partial sensing. This example in FIG. 12 is similar to that in FIG. 11, but partial sensing in FIG. 12 is specifically periodic based partial sensing, and the minimum sensing requirement may specify a default sensing occasion, i.e., the most recent sensing occasion, for partial sensing during the SL DRX inactive time. A UE may be configured or pre-configured with partial sensing occasions (block 1202). The partial sensing occasions may be included in a partial sensing configuration that is (pre-)configured to the UE. The UE may determine whether a slot is within the DRX active time or DRX inactive time of the UE (block 1204), or whether the UE is during the DRX active time or DRX inactive time of the UE. When the slot is within the DRX active time of the UE, the UE may perform partial sensing according to the slot on the configured sensing occasions (block 1206), and according to configured sensing periodicities (or default periodicities in sl-ResourceReservePeriodList). When the slot is within the DRX inactive time of the UE, the UE may perform partial sensing according to the minimum sensing requirement, i.e., perform the partial sensing only or at least on the most recent sensing occasion (block 1208). The UE may perform partial sensing for any periodicity in a periodicity list. If the slot belongs to the most recent sensing occasion, the UE will perform partial sensing on the slot. For other slots, e.g., if the slot does not belong to the most recent sensing occasion, depending on the specified or configured UE behavior (only or at least), the UE may either not perform sensing on the slot, or it is left to UE implementation.

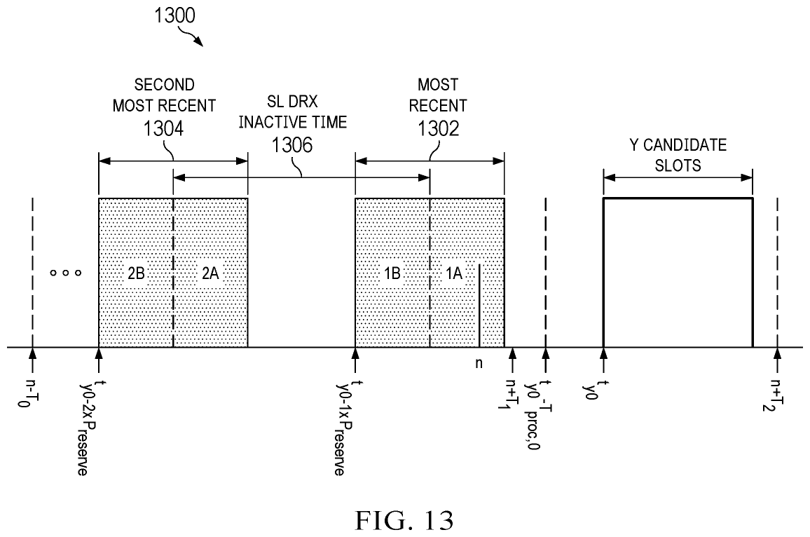

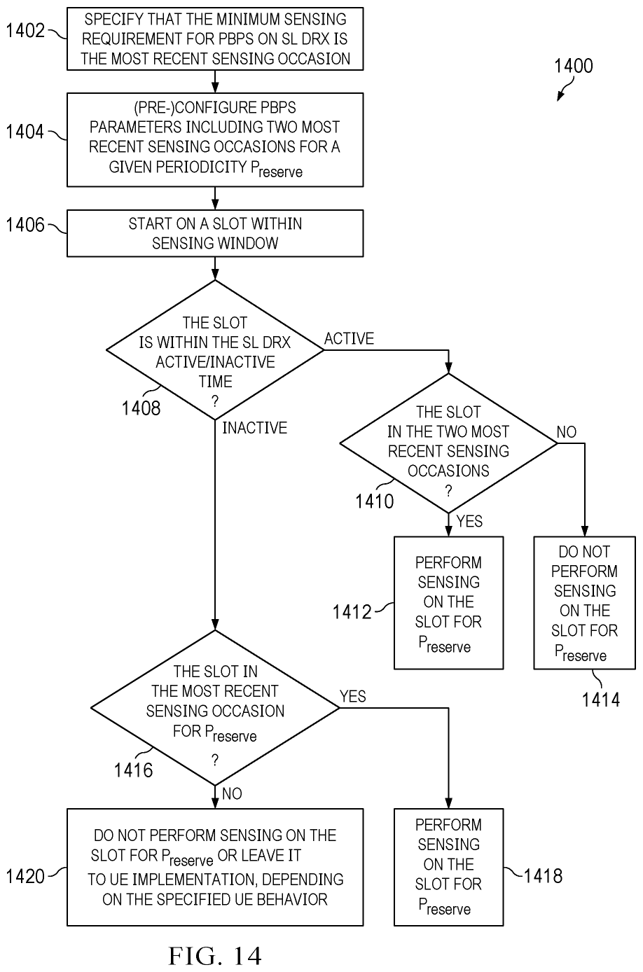

FIG. 13 is a diagram 1300 showing sensing occasions for periodic based partial sensing. FIG. 13 shows the two most recent sensing occasions configured for a given periodicity Pᵣₑₛₑᵣᵥₑ in the periodic based partial sensing: the most recent sensing occasions 1302 and the second most recent sensing occasions 1304 for Pᵣₑₛₑᵣᵥₑ. The slots of the SL DRX inactive time 1306 are also indicated in FIG. 13. Other slots in FIG. 13 are assumed to be the SL DRX active time. It can be seen that partial slots in the most recent sensing occasions 1302 are in the SL DRX active time (slots 1A), and partial slots are in the SL DRX inactive time 1306 (slots 1B). Similarly, for the second most recent sensing occasions 1304, a slot group 2A is in the SL DRX inactive time and a slot group 2B is in the SL DRX active time. Since two most recent sensing occasions (i.e., 1302 and 1304) are configured, from the earliest time, the UE will perform sensing on slots 2B as they belong to the second most recent sensing occasions 1304 for some of Y candidate slots. For the slots 2A, since they are in SL DRX inactive time, and the minimum requirement for the partial sensing is the most recent sensing occasion. Depending on the specification on the UE behavior, UE either does not perform the partial sensing on slots 2A or it is up to UE implementation whether to perform the sensing on the slots 2A. For the slots 1B, although they are in the SL DRX inactive time, since the configured minimum sensing occasion is the most recent sensing occasion, the UE performs sensing on slots 1B. Slots 1A are the most recent sensing occasion and are within the SL DRX active time, the UE performs sensing on these slots according to the configuration of periodic based partial sensing. Embodiment operations in this example are shown in FIG. 14.

FIG. 14 is a flow diagram showing embodiment operations 1400 for periodic based partial sensing during the SL DRX active/inactive time for a given periodicity. As shown, a rule may specify/configure that the minimum sensing requirement for PBPS on SL DRX is the most recent sensing occasion (block 1402). A UE may be (pre-)configured with PBPS parameters including the two most recent sensing occasions for a given periodicity Pᵣₑₛₑᵣᵥₑ (block 1404). The two most recent sensing occasions may include the most recent sensing occasion and the second most recent sensing occasion for the given Pᵣₑₛₑᵣᵥₑ. The UE may start sensing on a slot in a sensing window (1406). The UE may determine whether the slot is within the SL DRX active/inactive time (1408). When the slot is within the SL DRX active time, the UE may determine whether the slot belongs to the two most recent sensing occasions (block 1410). When the slot belongs to the two most recent sensing occasions, the UE may perform sensing on the slot for the given Pᵣₑₛₑᵣᵥₑ (block 1412). When the slot does not belong to the two most recent sensing occasions, the UE does not perform sensing on the slot for the given Pᵣₑₛₑᵣᵥₑ (block 1414). When the slot is within the SL DRX inactive time, the UE may determine whether the slot belongs to the most recent sensing occasion for Pᵣₑₛₑᵣᵥₑ (block 1416). When the slot belongs to the most recent sensing occasion for Pᵣₑₛₑᵣᵥₑ, the UE may perform sensing on the slot for Pᵣₑₛₑᵣᵥₑ (block 1418). When the slot does not belong to the most recent sensing occasion for Pᵣₑₛₑᵣᵥₑ, the UE may not perform sensing on the slot for Pᵣₑₛₑᵣᵥₑ, or may perform based on the UE's implementation (block 1420). What the UE performs in this case may depend on specified UE's behavior, which is based on the UE implementation, as previously described.

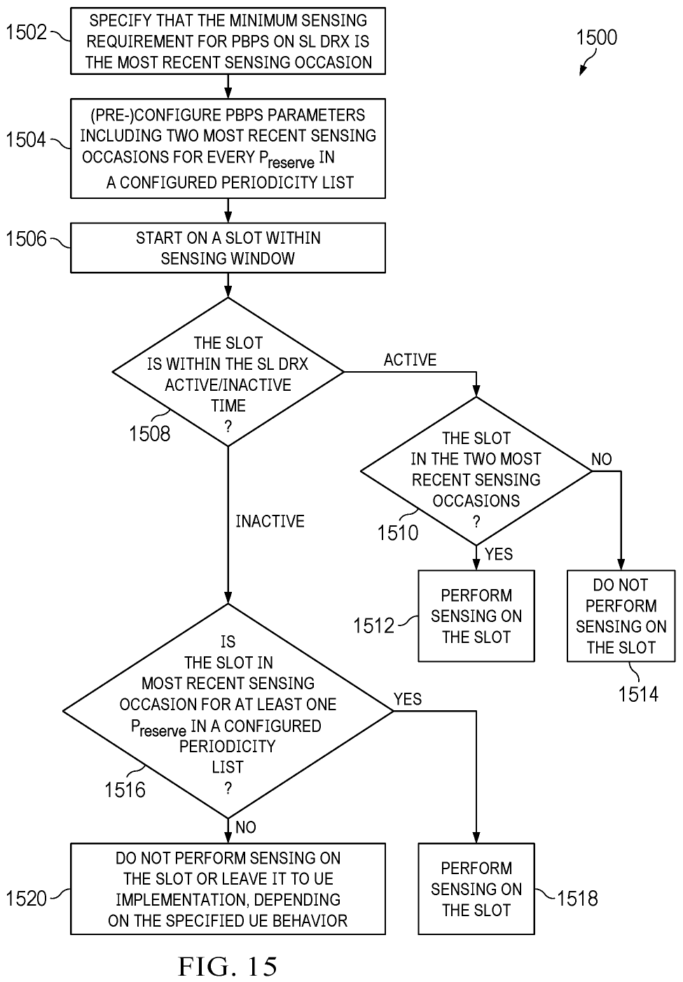

Note that for PBPS, there may be some overlaps on the sensing slots for different periodicities. Thus, it is possible that for a first periodicity, a sensing slot may not belong to the corresponding most recent sensing occasion for a candidate slot (i.e., a slot in the Y candidate slots), however, the sensing slot may belong to the most recent sensing occasion for a second periodicity. Therefore, a UE may still perform partial sensing on the sensing slot for the second periodicity. Since the UE detects PSCCH to obtain a periodicity for a conflict UE, when the UE performs sensing on the slot, it may check for any periodicity in a configured list as long as the associated candidate slot in the resource selection window is one of the Y candidate slots. FIG. 15 shows example operations based on this, where multiple or all periodicities in a configured list is considered.

FIG. 15 is a flow diagram showing embodiment operations 1500 for periodic based partial sensing during the SL DRX active/inactive time for various periodicities. As shown, a rule may specify/configure that the minimum sensing requirement for PBPS on SL DRX is the most recent sensing occasion (block 1502). AUE may be (pre-)configured with PBPS parameters including the two most recent sensing occasions for every periodicity Pᵣₑₛₑᵣᵥₑ in a configured periodicity list (block 1504). The two most recent sensing occasions may include the most recent sensing occasion and the second most recent sensing occasion for each Pᵣₑₛₑᵣᵥₑ. The UE may start sensing on a slot in a sensing window (1506). The UE may determine whether the slot is within the SL DRX active/inactive time (1508). When the slot is within the SL DRX active time, the UE may determine whether the slot belongs to the two most recent sensing occasions (block 1510). When the slot belongs to the two most recent sensing occasions, the UE may perform sensing on the slot (block 1512). When the slot does not belong to the two most recent sensing occasions, the UE does not perform sensing on the slot (block 1514). When the slot is within the SL DRX inactive time, the UE may determine whether the slot belongs to the most recent sensing occasion for at least one Pᵣₑₛₑᵣᵥₑ in the configured periodicity list (block 1516). When the slot belongs to the most recent sensing occasion for at least one Pᵣₑₛₑᵣᵥₑ, the UE may perform sensing on the slot (block 1518). When the slot does not belong to the most recent sensing occasion for any Pᵣₑₛₑᵣᵥₑ in the configured periodicity list, the UE may not perform sensing on the slot, or may perform based on the UE's implementation (block 1520). What the UE performs in this case may depend on specified UE's behavior, which is based on the UE implementation, as previously described.

A Tx UE may align its transmit slot with its SL DRX active time (also referred to as SL Tx UE DRX active time). When SL DRX is also enabled at a Rx UE of the Tx UE, the Tx UE may also need to align its transmit slot or resource selection window with the SL DRX active time of the Rx UE (also referred to as SL Rx UE DRX active time). For periodic based partial sensing, a Tx UE may align the Y candidate slots within both the SL Tx UE DRX active time and SL Rx UE DRX active time. However, if SL Tx UE DRX active time and SL Rx UE DRX active time are not aligned well with each other, e.g., due to decentralization, e.g., SL transmissions among UEs, it may be difficult to keep the configured Y candidate slot within the SL Rx UE DRX active time. The SL Tx UE may need to adjust its resource selection window or candidate Y slots, resulting in frequent change on the resource selection window or candidate slots.

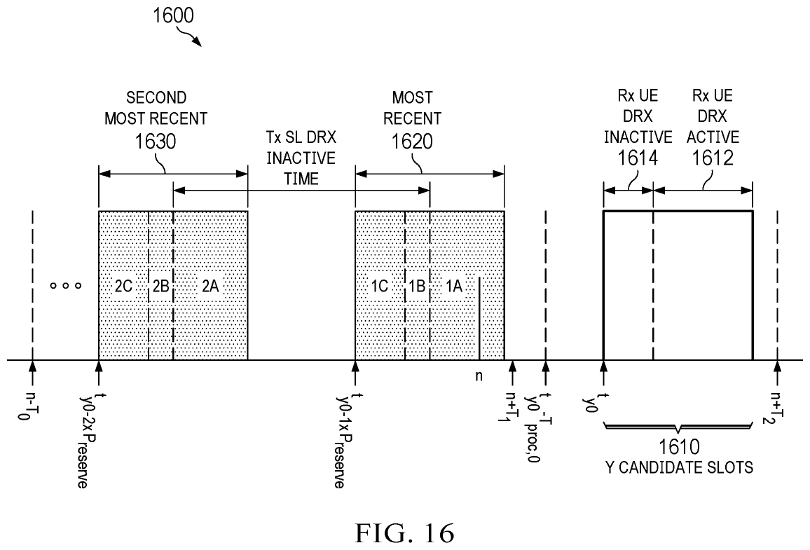

FIG. 16 is a diagram 1600 showing PBPS sensing occasions for a SL Tx UE configured with two most recent sensing occasions for a given Pᵣₑₛₑᵣᵥₑ according to embodiments of the present disclosure, where Y candidate slots are to be sensed by the SL Tx UE in a sensing window. FIG. 16 shows impact of SL Rx UE DRX on resource selection at the SL Tx UE for periodic based partial sensing. When using PBPS for periodic traffic as an example, the SL Tx UE may keep its Y candidate slots unchanged. The Y candidate slots 1610 may be divided into two sets, with one set within the SL Rx UE DRX active time and the other set within the SL Rx UE DRX inactive time. For example, as shown, the Y candidate slots 1610 are divided into a slot set 1612 that is within the SL Rx UE DRX active time and a slot set 1614 that is within the SL Rx UE DRX inactive time.

In this case, the Tx UE may perform sensing and resource selection similarly to the case where Rx UE DRX is not enabled. The Tx UE may select a resource in the SL Rx UE DRX inactive time, resulting in performance degradation. Therefore, it would be desirable that the Tx UE selects a resource in the Rx UE's SL DRX active time, particularly for the initial transmission of the Tx UE.

To select a resource in the Rx UE's SL DRX active time, the Tx UE may either set its initial candidate resource set SA as the slots within the Y candidate slots on the SL Rx UE DRX active time, or still set SA as the resources in the Y candidate slots but exclude the candidate slots that are on the Rx UE's SL DRX inactive time before performing resource exclusion based on sensing results (i.e., excluding resources with measured RSRP on the associated sensing slots above a RSRP threshold) in the SL resource exclusion procedure.

Regarding sensing, the existing sensing principles and the proposed sensing schemes may still be applied without any changes. The sensing results associated with the slots in the SL Rx UE DRX inactive time are not used for resource selection. To avoid sensing and achieve better power saving performance, the embodiment technique may impose one additional rule on sensing when Rx UE SL DRX is enabled:
If the configured sensing slots associated with the Y candidate slots for a given periodicity are not in the SL Rx UE DRX active time, a UE does not perform sensing on resources in these slots for the given periodicity.

As aforementioned for PBPS, since there are some overlaps on the sensing slots for different periodicities, a UE may still perform periodic based partial sensing on a slot when its associated candidate slot is in the SL Rx UE DRX active time at least for one configured periodicity.

The above rule can be jointly applied to the partial sensing with the proposed sensing scheme for Tx UEs with SL DRX enabled. For example, as shown in FIG. 16 Error! Reference source not found., with the SL DRX enabled at both Tx and Rx UEs, the most recent sensing occasion 1620 for a given periodicity may be partitioned into three groups, i.e., group 1A in the SL Tx UE DRX active time/associated with slots in the SL Rx UE DRX active time, group 1B in the SL Tx UE DRX inactive time/associated with slots in SL Rx UE DRX active time, group 1C in the SL Tx UE DRX inactive time/associated with slots in the SL Rx UE DRX inactive time. Similarly, the second most recent sensing occasion 1630 are divided into three slot groups, i.e., group 2A in the SL Tx UE DRX inactive time/associated with slots in SL Rx UE DRX active time, group 2B in SL Tx UE DRX active time/associated with slots in SL Rx UE active time, group 2C in the SL Tx UE DRX active time/associated with slots in the SL Rx UE DRX inactive time. Based on the proposed partial sensing schemes for Tx SL DRX illustrated in FIG. 13 and FIG. 14, and an additional sensing rule for Tx UE resource selection when Rx UE SL DRX is enabled, the Tx UE may perform sensing on slots in 1A, 1B, and 2B, but not on slots in 1C, 2A, and 2C, for the given periodicity.

Due to a shorter sensing time in partial sensing, sensing results may be unreliable, particularly for the available resource ratios. Further, for supporting aperiodic transmissions, with a small sensing window, it is highly possible that there will be a resource collision, particularly when the available resource ratio determined based on the partial sensing is small. For example, when it is determined based on partial sensing that there are 20% available resources, this means that 80% resources are occupied, indicating a high system load. With a shorter sensing time, the variance of the actual available resource ratio for 20% based on the partial sensing is much larger than that based on the full sensing. Hence, the collision probability based on this partial sensing result may be much higher compared with full sensing. Another issue is due to the smaller candidate pool for a small value Y. For the same available resource ratio, e.g., 20%, the available candidate resources for the partial sensing are much less than that for full sensing.

With SL DRX enabled, the sensing slots can be further reduced, consequently, the ability of collision detection is reduced. To achieve better collision avoidance, SL DRX may be enabled at a Tx UE, and different thresholds (X %) may be set/used for the available resource ratio in the resource exclusion procedure, e.g., to check against the criterion in the final step to terminate the exclusion procedure, when SL DRX is enabled.

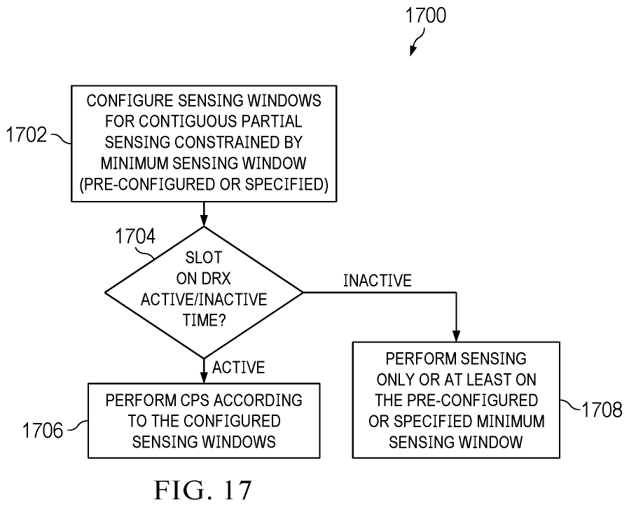

FIG. 17 is a flow diagram of embodiment operations 1700 for contiguous partial sensing. FIG. 17 shows an example for partial sensing and SL DRX with one configured parameter set and specified rules for CPS on SL DRX inactive time. In this example, the minimum sensing requirement may specify a configured minimum CPS sensing window. As shown, a UE may be configured with sensing windows for CPS, constrained by a minimum sensing window (block 1702). The sensing windows and the minimum sensing window may be pre-configured or specified. The UE may determine whether a slot is within the SL DRX active time or SL DRX inactive time of the UE (block 1704). When the slot in within the SL DRX active time, or when the UE is during the SL DRX active time, the UE may perform the CPS according to the configured sensing windows (block 1706). When the slot in within the SL DRX active time, or when the UE is during the SL DRX inactive time, the UE may perform sensing only or at least on slots in the minimum sensing window (block 1708). For other slots in the configured sensing windows, depending on the specified or configured UE behavior, the UE may either not perform sensing, or it is left to UE implementation. The minimum sensing window may be aligned with a configured sensing window at the starting slot n+T_{A} or the ending slot n+T_{B}.

Since a sensing window of the contiguous partial sensing is generally small, one alternative solution is to always perform sensing in the SL DRX inactive time according to a CPS configuration, the same as the UE is in the SL DRX active time.

If a UE is configured with full sensing, the minimum sensing requirement may be the default configuration for PBPS (i.e., the default configuration may include the most recent sensing occasion and a default periodicity list sl-Resource ReservePeriodList), and/or the configured minimum sensing window for CPS. Therefore, during the SL DRX inactive time, the UE may perform the PBPS on slots of the most recent sensing occasion for periodicities in sl-ResourceReservePeriodList, and/or perform the CPS on slots in the minimum sensing window for either periodic traffic or aperiodic traffic. The UE needs to support partial sensing in this case.

Aperiodic/dynamic transmission is supported in sidelink communications. For sidelink resource allocation, a UE may detect possible aperiodic traffic from other UEs to avoid resource conflicts. For this purpose, the UE may perform contiguous based partial sensing for resource (re)selection. Contiguous based partial sensing may be specified for resource allocation for both periodic traffic and aperiodic traffic for the sensing UE. The numbers, timing, or the window sizes described here are in slots for illustration purpose only.

### Periodic Based Partial Sensing and Contiguous Partial Sensing for Periodic Traffic

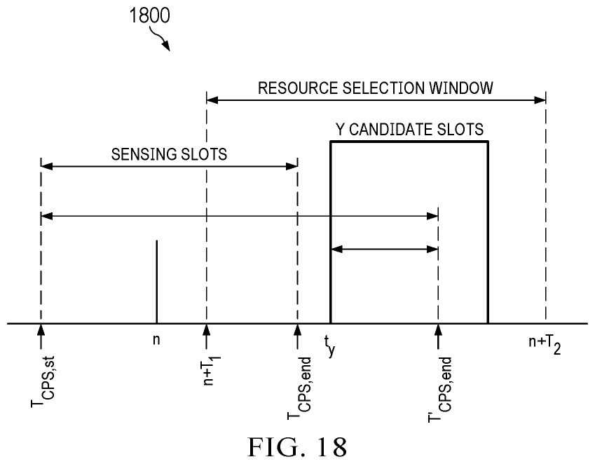

FIG. 18 is a diagram 1800 showing embodiment timing for contiguous based partial sensing for SL transmissions of periodic traffic. For a sensing UE with periodic traffic, as shown in Error! Reference source not found. FIG. 18, when resource (re)selection is triggered at slot n, the UE may select a resource from a set of Y candidate slots within a resource selection window [n+T₁, n+T₂]. The starting slot of the Y candidate slots is at slot t_{y}. If the UE performs contiguous based partial sensing, it monitors slots between [T_{CPS,st}, T_{CPS,end}].

For aperiodic traffic, the UE may select multiple candidate resources, but with the restriction that the gap between two consecutive candidate resources must be smaller than 32 slots. For example, when a resource is selected on slot m₁, meaning that the other candidate resource is located in the range of slots [m₁−31, m₁₊₃₁]. Therefore, to select resources in the set of Y candidate slots, it is meaningless to monitor the slot t_{y0}−32 or before. t_{y0} is the first slot (in the time domain) of the Y candidate slots. Thus, the starting point of contiguous partial sensing can be T_{CPS,st}=t_{y0}−31. Since for periodic traffic, n is known in advance, it is fine that t_{y0}-31<n. Given the time to complete the sensing process and resource selection processing, the ending slot for contiguous partial sensing may be T_{CPS,end}=t_{y0}−T_{proc,0}−T_{proc,1}. The contiguous partial sensing is similar to the re-evaluation process, and in order to provide a better resource selection, an embodiment technique may limit the processing time to T_{proc,1}. The embodiment technique may then have T_{CPS,end}=t_{y0}−T_{proc,1}. The sensing window for the contiguous partial sensing may be [t_{y0}−31, t_{y0}−T_{proc,1}]. From the agreement in RAN1 #104-e for contiguous partial sensing, a UE monitors the slots between [n+T_{A}, n+T_{B}]. With these notations, the embodiment technique may then have T_{A}=−n+t_{y0}−31, T_{B}=−n+t_{y0}−T_{proc,1}.

As aforementioned, monitoring a slot can only detect resource occupancy or reservation from aperiodic traffic within 32 slots. Then monitoring slot t_{y0}−31 is only useful for resource selection on t_{y0}, and monitoring slot t_{y0}−30 is only useful for slots t_{y0}, t_{y0}+1, and so on. The slot in the sensing window closest to t_{y0} has the largest coverage in the resource selection region. For this reason, to achieve better power saving, an embodiment technique may reduce the window size for contiguous partial sensing. For contiguous partial sensing for periodic traffic, sensing may start later than t_{y0}−31. Therefore, t_{y0}−31 may serve as the earliest slot for contiguous partial sensing for the periodic reservation. Therefore, the embodiment technique may have the minimum T_{A}, i.e., T_{A,min}, provided by n+T_{A,min}=t_{y0}−31, and T_{A,min}=t_{y0}−31-n.

For flexibility, the sensing starting point can be configured from a predefined range or a predefined list, with the earliest point being on slot t_{y0}−31. For example, a list of T_{CPS,st} or T_{A} may be specified, e.g., T_{CPS,st}=t_{y0}-└a×32┘+1, or T_{A}=−n+t_{y0}−└a×32┘+1, where a=1, ½, ¼, . . . .

It is possible that there is an overlap between the slots for the contiguous partial sensing and periodic based partial sensing occasions. Based on the sensing results from the contiguous partial sensing and periodic partial sensing if available, a UE may select a resource from the set of Y candidate slots within the resource selection window. After selecting the resource, the UE may perform re-evaluation and pre-emption if configured.

The sensing results may be unreliable due to the short sensing window size. On the other hand, the value of Y may be larger than 32. Contiguous partial sensing does not provide any benefit for resource selection on slots [t_{y0}−T_{proc,1}+32, t_{y0}+Y−1]. Further, if a sensing UE detects many aperiodic traffic within the sensing window [t_{y0}−31, t_{y0}−T_{proc,1}], which indicates that many resources are occupied on [t_{y0}, t_{y0}−T_{proc,1}+31], relying on periodic sensing results for resource allocation on [t_{y0}−T_{proc,1}+32, t_{y0}+Y−1] may cause many resource conflicts. Therefore, a different threshold on the available resource ratio X % is desirable than that in the full sensing for data with the same priority. Contiguous partial sensing may be beneficial if the number of available resources on [t_{y0}, t_{y0}−T_{proc}, 1+31] is small. However, different from the re-evaluation process where a transmission resource is allocated, e.g., a slot m, this information is not known in advance during the partial sensing. Setting the sensing slot based on m is not appropriate. Although it is possible to report available candidate resource set SA to the MAC layer on some slots and getting a grant on slot m, this two-stage process may functionally overlap with the re-evaluation process. Since the purposes of initial sensing and re-evaluation are different, with one for resource allocation and the other for checking resource conflicts, it is desirable to separate them in the specification. Therefore, a UE may be allowed to continue sensing until T′CPS,end. Although the UE can continue sensing until the slot T′CPS, end=t_{y0}+Y−1−T_{proc,1}, which may only leave a maximum of 1 slot for resource selection, it is better to set an offset, i.e., T′_{CPS,end}=max(t_{y0}−T_{proc,1},t_{y0}+Y−1−Tprox,1−T′_{CPS,offset}). T′_{CPS, offset,} can be viewed as the minimum resource selection window size, which can be fixed to 31 or a smaller value, or be configured. A UE may report the available resources any time after slot t_{y0}−T_{proc,1} to the MAC layer. Then based on T′_{CPS,end} and the notation in option 1 from RAN1 #104e, an embodiment technique may then have T′_{B}=−n+max(t_{y0}−T_{proc,1}, t_{y0}+Y−1−T_{proc,1}−T′_{CPS,offset}).

Based on above descriptions, an embodiment technique may set the minimum and maximum values related to the sensing boundary, i.e., T_{B,min} and T_{B, max} for contiguous partial sensing for transmission of periodic traffic, where T_{B,min}=t_{y0}−T_{prox,1,} T_{B,max}=−n+max(t_{y0}−T_{prox,1}, t_{y0}+Y−1−T_{prox,1}−T′_{CPS,offset}). A UE may report an available resource set any time on [T_{B,min}, T_{B,max}]. After a resource is selected, it is up to the UE to perform re-evaluation or pre-emption.

If a UE performs resource selection after n+T_{B}, the UE may continue contiguous partial sensing until n+T_{B,max} for re-evaluation and per-emption.

### Contiguous Partial Sensing for Aperiodic Traffic

For a UE with aperiodic traffic, a data packet may arrive at any time without any prior knowledge. Therefore, it is impossible for the UE to know in advance when resource selection is triggered at slot n. Thus, contiguous based partial sensing for aperiodic traffic can only start after n, i.e., T_{CPS,st}>n, as shown in FIG. 9. The earliest possible starting point is T_{CPS,st}=n+1, i.e., T_{A}=1.

When a UE performing contiguous partial sensing and resource (re-)selection is triggered at slot n, to achieve the maximum power saving, the UE may perform partial sensing with a minimum window size in order to obtain reliable sensing results for resource selection. Since the 1^{st}-stage SCI only informs the resource reservations located within a window of 32 slots, contiguous partial sensing for detecting aperiodic traffic from other UEs may only be beneficial for resource selection on the subsequent 31 slots. Therefore, the minimum sensing window size for contiguous partial sensing should be smaller than 32. If considering the required time for processing sensing results and resource selection, the slots for resource selection affected by the contiguous partial sensing is in [T_{CPS,end}+T_{proc},0+T_{proc,1}, T_{CPS,end}+31]. Therefore, the minimum sensing window size, W_{CPS,min} should be smaller than 32−(T_{proc,0}+T_{proc,1}) (in slots), i.e., it can be 31−(T_{proc,0}+T_{proc,1}) or smaller. An embodiment technique may have T_{B}−T_{A}+12 W_{CPS,min} subject to the change due to the PDB constraint.

On slots [T_{CPS,end}+32, n+T₂] in the resource selection window, the resource selection is equivalent to random resource selection. The sensing window size T_{CPS,end}−T_{CPS,st}+1 may also impact the reliability of the reported candidate resources on [T_{CPS,end}+T_{proc},0+T_{proc,1}, T_{CPS,end}+31]. The available resource ratio on [T_{CPS,end}+T_{proc,0}+T_{proc,1}, T_{CPS,end}+31] derived from contiguous partial sensing is one factor for resource selection. If the ratio is small, the available resources ratio on slots [T_{CPS,end}+32, n+T₂] may also be small. Assuming that the resources on slots [T_{CPS,end}+32, n+T₂] are all available, reporting them in SA may lead to a high conflict rate. To solve this issue, an embodiment is to specify a different threshold on the available resource ratio X % for resource exclusion. Further, if the available resource ratio is not large enough, the UE may continue sensing instead of reducing the RSRP threshold. The UE may stop sensing when the available resources are enough for the resource selection. The sensing window may be increased in a predefined value. Another embodiment solution is to restrict the resource selection window in an effective range of the contiguous partial sensing, i.e., [T_{CPS,end}+T_{proc,0}+T_{proc,1}, T_{CPS,end}+31]. Therefore, similar to the minimized sensing window, this embodiment technique may specify a minimum resource selection window size, which can also be 31−(T_{proc,0}+T_{proc,1}) or smaller.

When aperiodic traffic is triggered at slot n, the remaining packet delay budget (PDB) is provided by the higher layer, meaning that the transmission may happen on or before slot n+PDB. With the determined minimum resource selection window size, the sensing window of the contiguous partial sensing for resource selection should end on or before slot n+PDB-W_{RSW,min}. Considering the sensing process and resource selection time, the latest slot for the contiguous partial sensing is n+PDB−W_{RSW,min}−(T_{proc,0}+T_{prox,1}). Therefore, the upper bound of T_{B}, T_{B,max}, is PDB−W_{RSW,min}−(T_{proc,0}+T_{proc,1}).

With the minimum sensing window size and the upper bound T_{B,max}, the range of T_{B} is then given by T_{B}>W_{CPS,min}+T_{A}-1 and T_{B}≤PDB−W_{RSW,min}−(T_{proc,0}+T_{proc,1}). If the PDB is very small, an embodiment technique may have the case PDB−W_{RSW,min}−(T_{proc},0+T_{prox,1})<W_{CPS,min}+T_{A}−1. If this happens, one of the constraints is violated. The condition of the minimum resource selection window size may be more critical. Since random resource selection is a power saving scheme for sidelink resource selection in Rel-17, when the PDB is so small that PDB-W_{RSW,min}−(T_{proc,0}+T_{proc,1})<W_{CPS,min}+T_{A}−1, the constraint of minimum sensing window size can be neglected. Then, an embodiment technique can set T_{B}≤PDB−W_{RSW,min}−(T_{proc,0}+T_{proc,1}). To ensure maximum sensing duration and achieve better packet reception ratio (PRR) performance, the embodiment technique can set T_{B} to its upper bound, T_{B, max}.

When aperiodic traffic arrives at the UE, the UE may happen to perform periodic based partial sensing for periodic reservation for another transmission block. The sensing results from the periodic based partial sensing may be used for the resource selection for the aperiodic traffic. Since the aperiodic traffic is known only at slot n when it arrives, it will not be beneficial to start a new periodic based partial sensing for a set of Y candidate slots for resource selection for the aperiodic traffic, as most sensing slots based on the PBPS configuration already passed. Therefore, the UE may not start/initiate a new PBPS to determine a set of Y candidate slots within the resource selection window and monitor the corresponding periodic sensing occasions in addition to the periodic sensing occasions of the existing PBPS(s).

### Sensing and Inter-UE Coordination

In some embodiments, full sensing and partial sensing may be utilized to assist UEs' resource selection for enhancing power saving or reliability, which may be referred to as inter-UE coordination. As an example, in inter-UE coordination Scheme 2 (described later) for sidelink, a UE, e.g., UE-B, may reserve one or more resources for PSSCH transmission and signal in SCI the reserved resource(s). A UE to assist UE-B, e.g., UE-A, may send coordination information to UE-B that informs whether there is a conflict on the scheduled resource(s). The resource conflict may be the result of other UE(s) reserving the same resource or UE-A (or a receive UE) scheduling the same resource for its own transmission.

In Release-17 (and RAN1 #104b-e meeting), it was further agreed that two inter-UE coordination schemes, i.e., inter-UE coordination Scheme 1 and inter-UE coordination Scheme 2 as described below, are supported in Release-17.
Inter-UE Coordination Scheme 1:
   The coordination information sent from UE A to UE B includes the set of resources preferred and/or non-preferred for UE B's transmission.
      For future study (FFS) details including a possibility of down-selection between the preferred resource set and the non-preferred resource set, whether or not to include any additional information other than indicating time/frequency of the resources within the set in the coordination information,
      FFS condition(s) in which Scheme 1 is used.
Inter-UE Coordination Scheme 2:
   The coordination information sent from UE A to UE B includes the presence of expected/potential and/or detected resource conflict on the resources indicated by UE B's SCI.
      FFS details including a possibility of down-selection between the expected/potential conflict and the detected resource conflict.
      FFS condition(s) in which Scheme 2 is used.

For inter-UE Coordination Scheme 2, an embodiment method may send a one-bit indicator (conflict indicator) to let UE-B knows if a conflict happened (or may happen). A PSFCH or PSFCH like channel (e.g., a channel occupying the same PSFCH resource but with a different signaling format) may be utilized for carrying the conflict indication in Inter-UE Coordination Scheme 2. An embodiment provides a scheme on how the PSFCH resource is allocated for UE-A to send the conflict indicator, which can be applied to both existing PSFCH and new PSFCH-like signaling format.

For HARQ in sidelink communication mode 2, once a resource for PSSCH transmission is reserved, the feedback PSFCH channel is also determined based on configurations and specified rules on the PSSCH-PSFCH association in NR Rel-16.

FIG. 19 is a diagram 1900 of embodiment resources allocated for PSSCH and PSFCH. FIG. 19 shows slot-subchannel allocations of PSFCH or PSFCH like channels for coordination information transmissions using PSFCH associated with the first scheduled PSSCH indicated in SCI. As shown in FIG. 19, UE-B may reserve resource(s) 1910 and 1920 for PSSCH transmissions (PSSCH resource(s)), which may be signaled in one SCI 1930 to UE-A and obtained by UE-A. One PSSCH resource of the resources, e.g., the first/earliest PSSCH resource 1910, that are reserved by UE-B and indicated in the UE-B's SCI 1930, may be used to determine a resource (e.g., resource 1940) for UE-A to send the coordination information. The resource may be a PSFCH resource including a slot, a subchannel, and/or a PSFCH PRB set. The rest of the PSSCH resources 1910 and 1920 are used for data transmissions, and to determine a PSFCH resource, e.g., 1950, for a PSSCH transmission. UE-A's coordination may be needed to assist UE-B to know whether there is a resource conflict for the data transmissions. The PSSCH resource 1910 that indicates the PSFCH location may be used only for indicating the PSFCH resource for coordination without a real data transmission, i.e., a virtual PSSCH, or may be used for a data transmission. If the first PSSCH reservation 1910 is used for data transmission, there may not be coordination information of expected conflict indication for this PSSCH in advance as the associated PSFCH always appears. This may not be an issue if it is periodic reservation and transmissions. The PSFCH location indicated by one PSSCH transmission may always be used for transmitting the coordination information to indicate whether there is any expected/potential conflict for the subsequent resource reservation. However, upon the configuration, the PSFCH for coordination can be used for indicating whether there was a conflict for this PSSCH just transmitted. Further, even for aperiodic transmission, the resource reservation indicated in SCI follows a chain procedure.

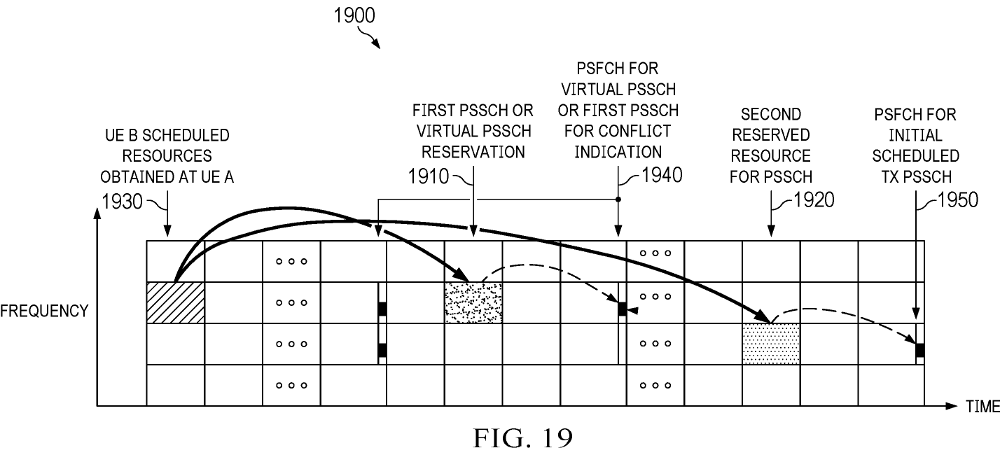

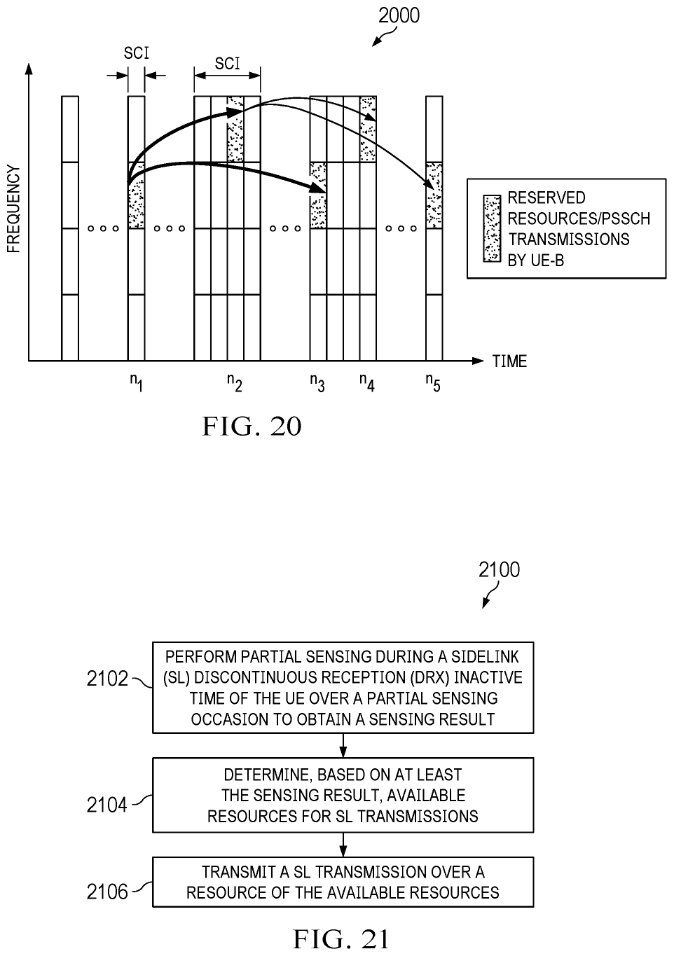

Even for aperiodic transmissions, resource reservation indicated in SCI may follow a chain procedure. FIG. 20 is a diagram 2000 showing SCI and reserved/scheduled resources. FIG. 20 shows a chain procedure for resource reservation indicated in SCI. As show in FIG. 20, a UE may send SCI on slot n1 and the SCI indicates two reserved resources on slots n2 and ng for PSSCH transmissions. When the UE transmits a PSSCH on slot n2, the SCI in the PSCCH on the same resources indicates the next two reserved resources on slots n4 and n5. On the resources of slots n3, n4, and/or n5, the UE again may signal subsequent reserved resources in the SCI via PSCCH on these resources. The reserved resources may be used for either retransmission of an existing transport block (TB) or a new TB.

After the slot, subchannel, and PSFCH PRB set of the PSFCH resource for coordination information are determined, the exact PSFCH resource in the PSFCH PRB set needs to be determined as a PSFCH PRB set may include multiple PSFCH resources. In Rel-16, the index of a PSFCH in the PSFCH PRB set associated to a PSSCH may be determined by the following formula:

$$j = ( {T}_{ID} + {R}_{ID} ) mod L ,$$

where L is the total number of PSFCH's in the PRB set, T_{ID} is the layer 1 ID of a transmit UE (i.e., the source ID in the 2^{nd} stage SCI), and R_{ID}=0 for unicast ACK/NACK feedback or groupcast option 1 NACK-only feedback. R_{ID} uses receiver ID for groupcast option 2 ACK/NACK feedback. That is, when the cast type indicator in Table 8.4.1.1-1 is ‘01’, R_{ID} is set to the receiver ID.

If there is no real data transmission on the PSSCH, e.g., a virtual PSSCH, for location indication of a coordination PSFCH, the same index expression in Rel-16 can be used. This may also be applied to the case where a new PSFCH format is defined and there is no signaling conflict with the existing PSFCH signal on the same PSFCH resource.

If no new PSFCH signaling format is defined, and there is a real data transmission on the PSSCH, to indicate either detected conflict for the transmitted PSSCH or the expected/potential conflict for the reserved resource in the future, a PSFCH resource in the PSFCH PRB set other than the one associated with the PSSCH for indicating coordination PSFCH may be selected to avoid the PSFCH collision. For example, to avoid collision with UE-B's other transmission on the PSSCH associated with the assigned PSFCH for conflict indication, an embodiment rule is to add an offset A in the PSFCH index formula as follows:

$$j = ( {T}_{ID} + {R}_{ID} + Δ ) mod L .$$

The value of the offset A can be fixed, configured by higher layer, or signaled via physical layer signaling, e.g., SCI.

FIG. 21 is a flow diagram of an embodiment method 2100 for sidelink resource sensing. The method 2100 may be indicative of operations at a UE. As shown, the UE performs partial sensing during a sidelink (SL) discontinuous reception (DRX) inactive time of the UE over a first partial sensing occasion to obtain a first sensing result (block 2102). The partial sensing may include periodic based partial sensing (PBPS) or contiguous partial sensing (CPS). The first partial sensing occasion may include a most recent sensing occasion for the PBPS or a minimum number of slots for the CPS. The UE may determine, based on at least the first sensing result, available resources for SL transmissions (block 2104). The UE may transmit a SL transmission over a resource of the available resources (block 2106).

In this example of FIG. 21, the UE may be enabled to perform partial sensing during the SL DRX inactive time, e.g., based on a received configuration, or based on a pre-configuration. The UE may be enabled or disabled to perform SL reception of PSCCH and RSRP measurement for partial sensing on slots in the SL DRX inactive time. The UE may also be enabled or disabled for SL DRX. The UE may be configured with a SL resource selection mechanism, such as full sensing only, partial sensing only, random resource selection only, or any combination(s) thereof, and based thereon, the UE selects one or more resources for SL communications.

The UE may perform the PBPS only in the most recent sensing occasion during the SL DRX inactive time. In some embodiments, the UE, when being outside of the SL DRX inactive time, may perform partial sensing over a second partial sensing occasion to obtain a second sensing result. The second partial sensing occasion may include at least a second most recent sensing occasion for the PBPS or a configurable number of slots for the CPS. The available resources for SL transmissions may be determined based on the first sensing result and the second sensing result. The second partial sensing occasion may include the most recent sensing occasion and the second most recent sensing occasion for the PBPS. The most recent sensing occasion for the PBPS may be a default sensing occasion configured for the UE for the PBPS. In an example, the configurable number of slots for the CPS may be from 0 to 30, and the minimum number of slots for the CPS is 0 for an aperiodic SL transmission. In another example, the configurable number of slots for the CPS may be from 5 to 30, and the minimum number of slots for the CPS is 5 for a periodic SL transmission.

In some embodiments, the UE may receive one or more sensing parameters of partial sensing, which may include one or more of the following:
a sensing periodicity list Pᵣₑₛₑᵣᵥₑ for the periodic based partial sensing;
one or more sensing occasions for the periodic based partial sensing;
a maximum number of sensing occasions for the periodic based partial sensing;
a default sensing occasion for the periodic based partial sensing during the SL DRX inactive time;
a sensing window for the contiguous partial sensing; or
a minimum sensing window for the contiguous partial sensing.

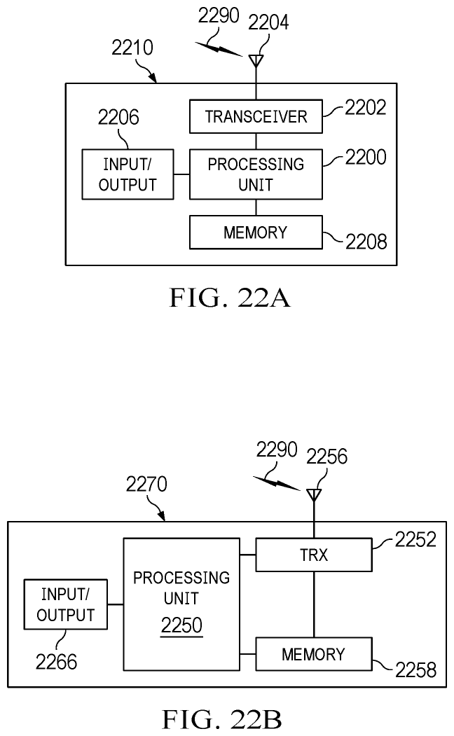

FIGS. 22A and 22B illustrate example devices that may be used to implement embodiments methods and teachings of this disclosure. In particular, FIG. 22A illustrates an example UE 2210, and FIG. 22B illustrates an example base station 2270.

As shown in FIG. 22A, the UE 2210 includes at least one processing unit 2200. The processing unit 2200 implements various processing operations of the UE 2210. For example, the processing unit 2200 could perform signal coding, data processing, power control, input/output processing, or any other functionality enabling the UE 2210 to implement the methods and teachings in this disclosure. The processing unit 2200 also supports the methods and teachings described in more detail above. Each processing unit 2200 includes any suitable processing or computing device configured to perform one or more operations. Each processing unit 2200 could, for example, include a microprocessor, microcontroller, digital signal processor, field programmable gate array, or application specific integrated circuit.

The UE 2210 also includes at least one transceiver 2202. The transceiver 2202 is configured to modulate data or other content for transmission by at least one antenna or NIC (Network Interface Controller) 2204, but typically more than one antenna for beamforming purposes. The transceiver 2202 is also configured to demodulate data or other content received by the at least one antenna 2204. Each transceiver 2202 includes any suitable structure for generating signals for wireless or wired transmission or processing signals received wirelessly or by wire. Each antenna 2204 includes any suitable structure for transmitting or receiving wireless or wired signals 2290. One or multiple transceivers 2202 could be used in the UE 2210, and one or multiple antennas 2204 could be used in the UE 2210. Although shown as a single functional unit, a transceiver 2202 could also be implemented using at least one transmitter and at least one separate receiver.

The UE 2210 further includes one or more input/output devices 2206 or interfaces. The input/output devices 2206 facilitate interaction with a user or other devices (network communications) in the network. Each input/output device 2206 includes any suitable structure for providing information to or receiving/providing information from a user, such as a speaker, microphone, keypad, keyboard, display, or touch screen, including network interface communications.

In addition, the UE 2210 includes at least one memory 2208. The memory 2208 stores instructions and data used, generated, or collected by the UE 2210. For example, the memory 2208 could store software or firmware instructions executed by the processing unit(s) 2200 and data used to reduce or eliminate interference in incoming signals. Each memory 2208 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 22B, the base station (or CU/DU/TRP with RRH) 2270 includes at least one processing unit 2250, at least one transceiver 2252, which includes functionality for a transmitter and a receiver, one or more antennas 2256, at least one memory 2258, and one or more input/output devices or interfaces 2266. A scheduler, which would be understood by one skilled in the art, is coupled to the processing unit 2250. The scheduler could be included within or operated separately from the base station 2270. The processing unit 2250 implements various processing operations of the base station 2270, such as signal coding, data processing, power control, input/output processing, or any other functionality. The processing unit 2250 can also support the methods and teachings described in more detail above. Each processing unit 2250 includes any suitable processing or computing device configured to perform one or more operations. Each processing unit 2250 could, for example, include a microprocessor, microcontroller, digital signal processor, field programmable gate array, or application specific integrated circuit.

Each transceiver 2252 includes any suitable structure for generating signals for wireless or wired transmission to one or more UEs or other devices. Each transceiver 2252 further includes any suitable structure for processing signals received wirelessly or by wire from one or more UEs or other devices. Although shown combined as a transceiver 2252, a transmitter and a receiver could be separate components. Each antenna 2256 includes any suitable structure for transmitting or receiving wireless or wired signals 2290. While a common antenna 2256 is shown here as being coupled to the transceiver 2252, one or more antennas 2256 could be coupled to the transceiver(s) 2252, allowing separate antennas 2256 to be coupled to the transmitter and the receiver if equipped as separate components. Each memory 2258 includes any suitable volatile or non-volatile storage and retrieval device(s). Each input/output device 2266 facilitates interaction with a user or other devices (network communications) in the network. Each input/output device 2266 includes any suitable structure for providing information to or receiving/providing information from a user, including network interface communications.

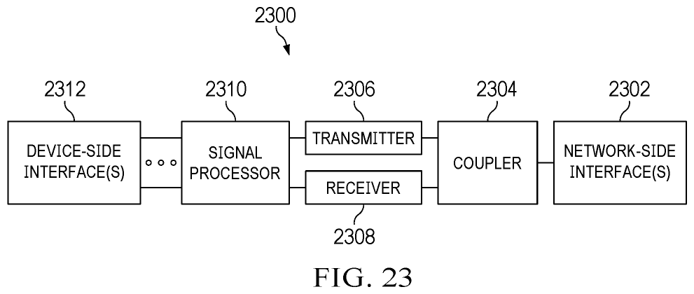

FIG. 23 is a block diagram of a transceiver 2300 adapted to transmit and receive signaling over a telecommunications network. The transceiver 2300 may be installed in a host device. As shown, the transceiver 2300 comprises a network-side interface 2302, a coupler 2304, a transmitter 2306, a receiver 2308, a signal processor 2310, and a device-side interface 2312. The network-side interface 2302 may include any component or collection of components adapted to transmit or receive signaling over a wireless or wireline telecommunications network. The coupler 2304 may include any component or collection of components adapted to facilitate bi-directional communication over the network-side interface 2302. The transmitter 2306 may include any component or collection of components (e.g., up-converter, power amplifier, etc.) adapted to convert a baseband signal into a modulated carrier signal suitable for transmission over the network-side interface 2302. The receiver 2308 may include any component or collection of components (e.g., down-converter, low noise amplifier, etc.) adapted to convert a carrier signal received over the network-side interface 2302 into a baseband signal. The signal processor 2310 may include any component or collection of components adapted to convert a baseband signal into a data signal suitable for communication over the device-side interface(s) 2312, or vice-versa. The device-side interface(s) 2312 may include any component or collection of components adapted to communicate data-signals between the signal processor 2310 and components within the host device (e.g., a processing system, local area network (LAN) ports, etc.).

The transceiver 2300 may transmit and receive signaling over any type of communications medium. In some embodiments, the transceiver 2300 transmits and receives signaling over a wireless medium. For example, the transceiver 2300 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 2302 comprises one or more antenna/radiating elements. For example, the network-side interface 2302 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 2300 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a partial sensing performing unit/module, a determining unit/module, a full sensing performing unit/module, a periodic based partial sensing unit/module, a contiguous partial sensing unit/module, a sidelink resource selection unit/module, a DRX unit/module; and/or a reference signal measurement unit/module. The respective units/modules may be hardware, software, or a combination thereof. For instance, one or more of the units/modules may be an integrated circuit, such as field programmable gate arrays (FPGAs) or application-specific integrated circuits (ASICs).

The following lists acronyms that may be used in the present disclosure:
3GPP third generation partnership project
5G Fifth generation
ACK Acknowledgement
CDMA Code division multiple access
CP Cyclic prefix
CPS Contiguous partial sensing
CSI channel state information
DL Downlink
DRX Discontinuous reception
EIRP Equivalent isotropic radiated power
gNB next generation node B
HARQ hybrid automatic repeat request
IC In-coverage
MAC Medium Access Protocol
MIB Master information block
NACK Negative acknowledgement
NR New Radio
OFDM Orthogonal frequency-division multiplexing
OOC Out-of-coverage
PBPS Periodic based partial sensing
PDB Packet delay budget
PDCCH Physical Downlink Control Channel
PDSCH Physical Downlink Shared Channel
PRB Physical Resource Block
PS Public safety
PSCCH Physical sidelink control channel
PSFCH Physical sidelink feedback channel
PSS Primary Synchronization Signal
PSSCH Physical sidelink shared channel
PUCCH Physical Uplink Control Channel
PUSCH Physical Uplink Shared Channel
PUSCH Physical Uplink Shared Channel
QAM Quadrature Amplitude Modulation
QCL quasi-co-location
QPSK Quadrature Phase Shift Keying
RE Resource element
RNTI Radio Network Temporary Identifier
RS Reference signal
RSRP Reference Signal Received Power
SCI Sidelink control information
SCS subcarrier spacing
SL Sidelink
UE User equipment
UL Uplink
V2X vehicle-to-everything

The following references are related to the subject matter of the present disclosure, and are hereby incorporated by reference in their entireties:
TS 38.212, “NR; Multiplexing and channel coding,” v 16.5.0, Mar. 30, 2021;
TS 38.321, “3rd Generation Partnership Project; Technical Specification Group Radio Access Network; NR; Medium Access Control (MAC) protocol specification (Release 16),” v 16.4.0, Mar. 29, 2021;
TS 23.287, “3rd Generation Partnership Project; Technical Specification Group Services and System Aspects; Architecture enhancements for 5G System (5GS) to support Vehicle-to-Everything (V2X) services (Release 16),” v 16.5.0, December 2020;
TS 38.213, “NR; Physical layer procedures for control,” v 16.5.0, Mar. 30, 2021;
TS 38.214, “NR; Physical layer procedures for data,” v 16.5.0, Mar. 30, 2021;
TS23.303, “Proximity-based services (ProSe); Stage 2,” 16.0.0, Jul. 9, 2020;
RP-202846, Dec. 7-11, 2020;
TS38.331, “NR; Radio Resource Control (RRC); Protocol specification,” v 16.4.1, Mar. 30, 2021; and
RAN #106-e meeting minutes, R1-2110434, Oct. 11, 2021.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method comprising:
performing, by a first user equipment (UE), partial sensing during a sidelink (SL) discontinuous reception (DRX) inactive time of the first UE over a first partial sensing occasion to obtain a first sensing result, the partial sensing comprising periodic based partial sensing (PBPS) or contiguous partial sensing (CPS), the first partial sensing occasion comprising a sensing occasion determined based on a most recent sensing occasion for the PBPS or a minimum number of slots for the CPS;
determining, by the first UE based on at least the first sensing result, available resources for SL transmissions; and
transmitting, by the first UE, a SL transmission over a resource of the available resources.

2. The method of claim 1, wherein the performing the partial sensing comprises:
when the first UE is enabled to perform the partial sensing during the SL DRX inactive time, performing, by the first UE, the partial sensing during the SL DRX inactive time of the first UE.

3. The method of claim 2, further comprising:
receiving, by the first UE, configuration information enabling the first UE to perform the partial sensing during the SL DRX inactive time.

4. The method of claim 1, further comprising:
performing, by the first UE, the partial sensing over a second partial sensing occasion to obtain a second sensing result, the second partial sensing occasion comprising a sensing occasion determined based on at least a second most recent sensing occasion for the PBPS or a configurable number of slots for the CPS; and
wherein the determining the available resources comprises:
determining, by the first UE based on the first sensing result and the second sensing result, the available resources for SL transmissions.

5. The method of claim 4, wherein the second partial sensing occasion comprises one or more sensing occasions determined based on the most recent sensing occasion and the second most recent sensing occasion for the PBPS.

6. The method of claim 1, wherein the most recent sensing occasion for the PBPS is a default sensing occasion configured for the first UE for the PBPS.

7. The method of claim 4, wherein the configurable number of slots for the CPS is from 0 to 30, and the minimum number of slots for the CPS is 0 for an aperiodic SL transmission.

8. The method of claim 4, wherein the configurable number of slots for the CPS is from 5 to 30, and the minimum number of slots for the CPS is 5 for a periodic SL transmission.

9. The method of claim 1, wherein the performing the partial sensing comprises:
determining, by the first UE, whether a slot during the SL DRX inactive time of the first UE is within the most recent sensing occasion; and
when the slot is within the most recent sensing occasion, performing, by the first UE, the PBPS in the slot.

10. The method of claim 9, further comprising:
when the slot is outside the most recent sensing occasion, skip performing, by the first UE, the PBPS in the slot.

11. The method of claim 1, wherein the performing the partial sensing comprises:
performing, by the first UE, the PBPS only in the most recent sensing occasion during the SL DRX inactive time.

12. The method of claim 1, wherein the performing the partial sensing comprises:
performing, by the first UE, the PBPS in the most recent sensing occasion during the SL DRX inactive time for a resource reservation periodicity in a periodicity list.

13. The method of claim 1, wherein the performing the partial sensing during the SL DRX inactive time comprises:
receiving, by the first UE, a physical sidelink control channel (PSCCH) in the first partial sensing occasion, the PSCCH indicating a SL resource reserved by a second UE; and
performing, by the first UE, reference signal received power (RSRP) measurement based on the PSCCH.

14. The method of claim 1, wherein the partial sensing is performed according to a configuration that is pre-configured to the first UE or received by the first UE.

15. The method of claim 14, wherein the configuration comprises one or more sensing parameters of the partial sensing, the one or more sensing parameters comprising one or more of:
a sensing periodicity list Pᵣₑₛₑᵣᵥₑ for the PBPS;
one or more sensing occasions for the PBPS;
a maximum number of sensing occasions for the PBPS;
a default sensing occasion for the PBPS during the SL DRX inactive time;
a sensing window for the contiguous partial sensing; or
a minimum sensing window for the contiguous partial sensing.

16. An apparatus comprising:
a non-transitory memory storage comprising instructions; and
one or more processors in communication with the non-transitory memory storage, wherein the instructions, when executed by the one or more processors, cause the apparatus to perform operations including:
performing partial sensing during a sidelink (SL) discontinuous reception (DRX) inactive time of the apparatus over a first partial sensing occasion to obtain a first sensing result, the partial sensing comprising periodic based partial sensing (PBPS) or contiguous partial sensing (CPS), the first partial sensing occasion comprising a sending occasion determined based on a most recent sensing occasion for the PBPS or a minimum number of slots for the CPS;
determining, based on at least the first sensing result, available resources for SL transmissions; and
transmitting a SL transmission over a resource of the available resources.

17. The apparatus of claim 16, wherein the performing the partial sensing comprises:
when the apparatus is enabled to perform the partial sensing during the SL DRX inactive time, performing the partial sensing during the SL DRX inactive time of the apparatus.

18. The apparatus of claim 17, the operations further comprising:
receiving configuration information enabling the apparatus to perform the partial sensing during the SL DRX inactive time.

19. The apparatus of claim 16, the operations further comprising:
performing the partial sensing over a second partial sensing occasion to obtain a second sensing result, the second partial sensing occasion comprising a sensing occasion determined on at least a second most recent sensing occasion for the PBPS or a configurable number of slots for the CPS; and
wherein the determining the available resources comprises:
determining, based on the first sensing result and the second sensing result, the available resources for SL transmissions.

20. A non-transitory computer-readable media storing computer instructions, that when executed by an apparatus, cause the apparatus to perform operations including:
performing partial sensing during a sidelink (SL) discontinuous reception (DRX) inactive time of the apparatus over a first partial sensing occasion to obtain a first sensing result, the partial sensing comprising periodic based partial sensing (PBPS) or contiguous partial sensing (CPS), the first partial sensing occasion comprising a sensing occasion determined on a most recent sensing occasion for the PBPS or a minimum number of slots for the CPS;
determining, based on at least the first sensing result, available resources for SL transmissions; and
transmitting a SL transmission over a resource of the available resources.
